(19) United States
(12) Patent Application Publication
(10) Pub. No.: US 2017/0335144 A1
(43) Pub. Date: Nov. 23, 2017

(54) OPTICAL ADHESIVE SHEET, POLARIZING FILM WITH ADHESIVE LAYER AND LIQUID CRYSTAL DISPLAY DEVICE

(71) Applicant: NITTO DENKO CORPORATION, Osaka (JP)

(72) Inventors: Kazuma MITSUI, Ibaraki-shi (JP); Masato FUJITA, Ibaraki-shi (JP); Takahiro NONAKA, Ibaraki-shi (JP); Masahiro EHARA, Ibaraki-shi (JP)

(73) Assignee: NITTO DENKO CORPORATION, Osaka (JP)

(21) Appl. No.: 15/448,815

(22) Filed: Aug. 10, 2017

(30) Foreign Application Priority Data
Mar. 7, 2016 (JP) 2016-043315
Jan. 16, 2017 (JP) 2017-005027

(51) Int. Cl. C09J 7/02; G02F 1/1333; G02F 1/1335; G02B 5/30; C09J 133/06

(52) U.S. Cl. CPC C09J 7/0246; G02F 1/133528; G02B 5/305; G02F 1/13338; C09J 2203/318; C09J 2201/606; C09J 2201/134; C09J 2201/128; C09J 133/066; C09J 2467/006; C09J 2469/006; C09J 2433/00

(57) ABSTRACT

An optical adhesive sheet having a lamination structure includes a first adhesive layer, a second adhesive layer, and a substrate located between the first and the second adhesive layers. The first adhesive layer has a thickness of 30 μm or more and a storage modulus of 1.0×10⁴ Pa or more at 95° C. The second adhesive layer has a loss tangent of 0.08 or more at 95° C. A polarizing film having a lamination structure including a polarizing film and the optical adhesive sheet. A liquid crystal display device having a multilayer structure including a resin-made covering member, a liquid crystal panel, and the optical adhesive sheet. In the liquid crystal display device, the optical adhesive sheet is attached to the resin-made covering member on the side of the first adhesive layer and attached to the polarizing film of the liquid crystal panel on the side of the second adhesive layer.

### TECHNICAL FIELD

The present invention relates to an optical double-sided adhesive sheet having optical transparency, a polarizing film with the optical adhesive sheet, and a liquid crystal display device with the optical adhesive sheet.

### BACKGROUND ART

A display device, such as a liquid crystal display, or an input device, such as a touch panel, has a multilayer structure portion including various substrates and films. In these devices, a double-sided pressure-sensitive adhesive sheet having light permeability may be used for bonding adjacent predetermined members in the multilayer structure or for filling an air gap between adjacent members. Such optical adhesive sheets are described, for example, in the following Patent Literatures 1 to 4.

### CITATION LIST

### Patent Literature

PTL 1: Japanese Unexamined Patent Application Publication (JP-A) No. 2012-78431

PTL 2: Japanese Unexamined Patent Application Publication (JP-A) No. 2012-188595

PTL 3: Japanese Unexamined Patent Application Publication (JP-A) No. 2015-200698

PTL 4: Japanese Unexamined Patent Application Publication (JP-A) No. 2016-26321

### SUMMARY OF INVENTION

### Technical Problem

A liquid crystal display device, such as an in-vehicle liquid crystal display, has a transparent cover constituting the foremost surface of the display screen. For example, a resin cover (resin-made covering member) such as a polycarbonate cover may be used as the transparent cover from the viewpoint of safety and light weight. The resin cover may generate so-called outgas (outgassing) under a high-temperature environment or a high-humidity environment. When an adhesive sheet is stuck to the resin cover, outgas from the cover can cause defects such as partial detachment or peeling of the adhesive sheet. Meanwhile, printing is often applied to the liquid crystal panel side surface of a transparent cover for a liquid crystal display along the cover periphery. The printing with a predetermined thickness forms a step on the liquid crystal panel side surface of the transparent cover. In the case where an adhesive sheet is stuck to the liquid crystal panel side surface of the transparent cover, step difference on the printed liquid crystal panel side surface may cause defects such as partial detachment of the adhesive sheet.

On the other hand, a liquid crystal panel with on-cell type touch sensors or a liquid crystal panel with in-cell type touch sensors, having a touch panel function incorporated in the liquid crystal panel, may be adopted in the liquid crystal display or the liquid crystal display device. A liquid crystal panel of touch panel incorporating type has a multilayer structure and includes a polarizing film often disposed at the outermost layer in the multilayer structure. The polarizing film is one of the elements for realizing a so-called liquid crystal shutter function. Polarizing films for liquid crystal panels tend to exhibit the property of shrinking when the temperature rises from room temperature and of expanding when the temperature falls to room temperature. The dimensional changes of the polarizing films in the surface spreading direction due to the temperature changes are relatively large.

The present invention has been made under such circumstances, and an object of the present invention is to provide an optical adhesive sheet which is suitable for filling a gap between a polarizing film and a resin cover in a liquid crystal display device. A further object of the present invention is to provide a polarizing film with the adhesive sheet and a liquid crystal display device with the adhesive sheet.

### Solution to Problem

According to a first aspect of the present invention, there is provided an optical adhesive sheet. The optical adhesive sheet has a lamination structure including a first adhesive layer, a second adhesive layer, and a substrate. The first adhesive layer has a thickness of 30 μm or more and a storage modulus of 1.0×10⁴ Pa or more at 95° C. The second adhesive layer has a loss tangent (=loss elastic modulus/storage modulus) of 0.08 or more at 95° C. The substrate is disposed between the first and the second adhesive layers and has a thickness of 15 to 150 μm. In a design in which a polarizing film of a liquid crystal panel in a liquid crystal display device faces a resin cover as a transparent cover, the optical adhesive sheet of the present invention is usable to fill the space between the polarizing film and the resin cover in a mode where the optical adhesive sheet is bonded to the resin cover on the first adhesive layer side and bonded to the polarizing film of the liquid crystal panel on the second adhesive layer side.

As described above, the first adhesive layer of the optical adhesive sheet of the present invention has a storage modulus of 1.0×10⁴ Pa or more at 95° C. Such a configuration is suitable for suppressing defects due to outgas from the resin cover such as partial detachment or peeling of the first adhesive layer or the optical adhesive sheet when the optical adhesive sheet is bonded to the transparent resin cover for liquid crystal display devices on the first adhesive layer side. That is, such a configuration is suitable for suppressing above-mentioned defects caused by outgas.

Further, as described above, the first adhesive layer of the optical adhesive sheet of the present invention has a thickness of 30 μm or more. Such a configuration is suitable for suppressing defects due to step difference on the resin cover printed surface, such as partial detachment of the first adhesive layer or the optical adhesive sheet, when the optical adhesive sheet is bonded to the transparent resin cover for liquid crystal display devices on the first adhesive layer side. That is, the configuration is suitable for securing step followability of the first adhesive layer to suppress occurrence of defects due to steps of printed portion in the bonded state.

In addition, as described above, the second adhesive layer of the optical adhesive sheet of the present invention has a loss tangent of 0.08 or more at 95° C. Such a configuration is useful in that, when the optical adhesive sheet is bonded to the polarizing film of the liquid crystal panel on the second adhesive layer side, the second adhesive layer or the adhesive sheet follows the dimensional change in the surface spreading direction or in-plane direction of the polarizing film according to temperature change to relax the stress at the bonding interface between the polarizing film and the second adhesive layer. Such relaxation of stress at the bonding interface between the polarizing film and the second adhesive layer is useful for securing the adhesion reliability of the second adhesive layer or the optical adhesive sheet to the polarizing film.

Furthermore, as described above, the substrate of the optical adhesive sheet of the present invention has a thickness of 15 to 150 μm. The configuration in which the thickness of the substrate is 15 μm or more is suitable for ensuring the function of the substrate as a support member at the time of handling such as bonding the optical adhesive sheet to suppress wrinkles in the adhesive sheet. The configuration in which the thickness of the substrate is 150 μm or less is suitable for suppressing defects due to step difference on the resin cover printed surface such as partial detachment of the optical adhesive sheet when the optical adhesive sheet is bonded to the transparent resin cover for liquid crystal display devices on the first adhesive layer side. That is, the configuration is suitable for securing step followability in the first adhesive layer to suppress occurrence of defects due to steps of printed portion in the bonded state. When the thickness of the substrate exceeds 150 μm, the rigidity of the substrate and, furthermore, the rigidity of the optical adhesive sheet including the substrate tend to be excessive. In the case where the rigidity of the optical adhesive sheet is excessive, the optical adhesive sheet often fails to ensure good step followability.

The optical adhesive sheet according to the first aspect of the present invention as described above is suitable for filling the space between the polarizing film and the resin cover in the liquid crystal display device.

Preferably, the first adhesive layer has a shear adhesive force to the polycarbonate of 10 N/cm² or more. Such a configuration is suitable for securing the adhesion reliability of the first adhesive layer or the optical adhesive sheet to a resin cover. Such a configuration is suitable for securing the adhesion reliability of the first adhesive layer or the optical adhesive sheet to a transparent polycarbonate cover, which is prone to outgas under a high temperature environment or a high humidity environment, when the polycarbonate cover is adopted as a resin cover of a liquid crystal display device.

Preferably, the first adhesive layer has a thickness of 500 μm or less. Such a configuration is suitable for securing a high shear adhesion force of the first adhesive layer to the resin cover.

Preferably, the second adhesive layer has a thickness of 100 μm or more. Such a configuration is suitable for securing the above-described followability of the second adhesive layer to the dimensional change of the polarizing film. The polarizing film is an adherend of the second adhesive layer. Therefore, the configuration is suitable for relaxing the stress at the bonding interface between the second adhesive layer and the polarizing film.

Preferably, the second adhesive layer has a thickness of 1000 μm or less. Such a configuration is suitable for securing a high shear adhesive strength of the second adhesive layer to the polarizing film.

Preferably, at least one of the first adhesive layer and the second adhesive layer contains an acrylic adhesive as a base component. Such a configuration is suitable for exerting an adhesive force as required for the adhesive layer of the optical adhesive sheet.

Preferably, at least one of the first adhesive layer and the second adhesive layer is a cured product of the active energy ray-curable adhesive composition. Use of active energy ray irradiation, such as ultraviolet irradiation, to cure the curable adhesive composition for forming an adhesive layer gives an appropriately cured adhesive layer, even if the coating film of the adhesive composition is relatively thick. Therefore, the configuration in which the first adhesive layer is a cured product of the active energy ray-curable adhesive composition is suitable for preparing a sufficiently cured first adhesive layer despite being relatively thick. Similarly, the configuration in which the second adhesive layer is a cured product of the active energy ray-curable adhesive composition is suitable for preparing a sufficiently cured second adhesive layer despite being relatively thick.

According to a second aspect of the present invention, there is provided a polarizing film with an adhesive layer. The polarizing film with an adhesive layer has a lamination structure including an optical adhesive sheet according to the first aspect of the present invention and a polarizing film. With such a configuration, it is possible to provide a polarizing film for liquid crystal panels in which an optical adhesive sheet has already been bonded. The optical adhesive sheet is suitable for filling the space between the polarizing film and the resin cover in the liquid crystal display device.

According to a third aspect of the present invention, there is provided a liquid crystal display device. The liquid crystal display device includes an optical adhesive sheet according to the first aspect of the present invention. The liquid crystal display device includes, for example, a multilayer structure of a resin cover, a liquid crystal panel having a polarizing film on its surface, and an optical adhesive sheet according to the first aspect of the present invention positioned therebetween. The optical adhesive sheet is bonded to a resin cover on the side of the first adhesive layer and bonded to the polarizing film of the liquid crystal panel on the side of the second adhesive layer. With such a configuration, the technical advantage described above with respect to the first aspect of the present invention can be obtained in the optical adhesive sheet between the resin cover and the polarizing film of the liquid crystal panel.

In a third aspect of the present invention, preferably, the liquid crystal panel includes on-cell type touch sensors or in-cell type touch sensors. A liquid crystal panel with on-cell type touch sensors or a liquid crystal panel with in-cell type touch sensors, in which a touch panel function is incorporated in a liquid crystal panel, reduces the thickness, weight, and manufacturing cost of the entire unit having both the touch panel function and the liquid crystal shutter function.

### BRIEF DESCRIPTION OF DRAWINGS

FIG. 1 is a partial cross-sectional view of an optical adhesive sheet according to one embodiment of the present invention.

FIG. 2 is a partial cross-sectional view of a polarizing film according to one embodiment of the present invention.

FIG. 3 is a partial multilayer configuration diagram of a liquid crystal display device according to one embodiment of the present invention.

### DESCRIPTION OF EMBODIMENTS

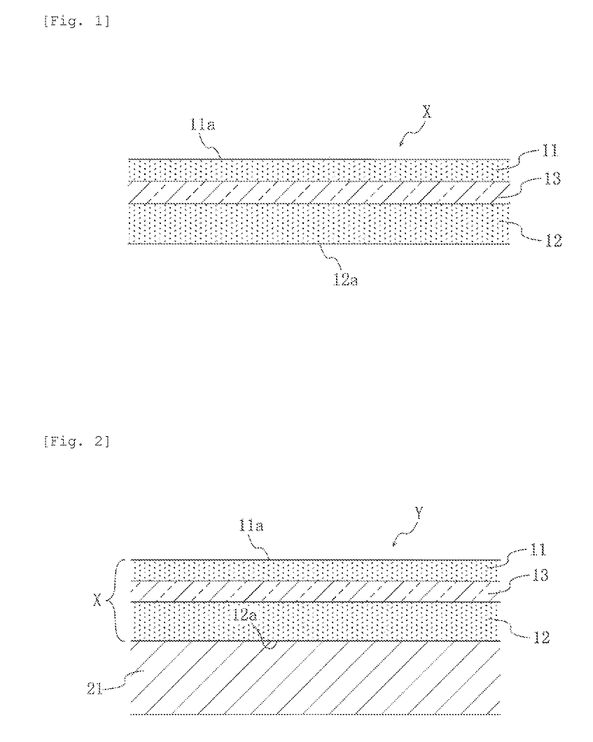

FIG. 1 is a partial cross-sectional view of an adhesive sheet X which is an optical adhesive sheet according to one embodiment of the present invention. The adhesive sheet X has a lamination structure including an adhesive layer 11 which is a first adhesive layer, an adhesive layer 12 which is a second adhesive layer, and a substrate 13 positioned therebetween. In the liquid crystal display device designed so that the resin cover which is a transparent cover and the polarizing film of the liquid crystal panel face each other in close proximity, the adhesive sheet X can be used as a transparent optical adhesive sheet for filling the space between the resin cover and the polarizing film. Specifically, in the liquid crystal display device designed as described above, the adhesive sheet X can be used as a transparent optical adhesive sheet for filling the space between the resin cover and the polarizing film of the liquid crystal panel in a mode in which the adhesive sheet X is bonded to the cover on the side of the adhesive layer 11 and bonded to the polarizing film on the side of the adhesive layer 12.

Each of the adhesive layers 11 and 12 of the adhesive sheet X contains, for example, an acrylic polymer which is an acrylic adhesive as a base component. The base component is a component which occupies the largest mass proportion among the constituents. Further, the adhesive layer 11 has an adhesive surface 11a that can be bonded to an adherend, and the adhesive layer 12 has an adhesive surface 12a that can be bonded to an adherend. Each of the adhesive layers 11 and 12 is, for example, a cured product of an acrylic adhesive composition. The adhesive composition for forming the adhesive layer 11 and the adhesive composition for forming the adhesive layer 12 may have the same composition or may have different compositions. The acrylic adhesive composition contains, for example, a monomer component for forming an acrylic polymer and/or a polymer component obtained by polymerizing the monomer component (partially polymerized substance), and a polyfunctional (meth)acrylate which is a copolymerizable crosslinking agent. As used herein, “(meth)acrylate” means “acrylate” and/or “methacrylate”.

The acrylic polymer contained in the adhesive layer 11 and/or the adhesive layer 12 is preferably a polymer containing, as the main monomer unit having the largest mass ratio, the monomer unit derived from an acrylic acid alkyl ester having a linear or branched alkyl group and/or a methacrylic acid alkyl ester having a linear or branched alkyl group. Hereinafter, “(meth)acrylic” represents “acrylic” and/or “methacrylic”.

(Meth)acrylic acid alkyl ester having a linear or branched alkyl group for forming the monomer unit of the acrylic polymer, that is, (meth)acrylic acid alkyl ester having a linear or branched alkyl group as the monomer for constituting the acrylic polymer includes (meth)acrylic acid alkyl esters having a linear or branched alkyl group having 1 to 20 carbon atoms. Examples of these (meth)acrylic acid alkyl esters include methyl (meth)acrylate, ethyl (meth)acrylate, propyl (meth)acrylate, isopropyl (meth)acrylate, n-butyl (meth)acrylate, s-butyl (meth)acrylate, isobutyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth) acrylate, tridecyl (meth) acrylate, tetradecyl (meth) acrylate, pentadecyl (meth)acrylate, hexadecyl (meth)acrylate, heptadecyl (meth) acrylate, octadecyl (meth) acrylate, isostearyl (meth)acrylate, nonadecyl (meth)acrylate, and eicosyl (meth)acrylate. As (meth)acrylic acid alkyl ester for the acrylic polymer, one kind of alkyl (meth)acrylate ester may be used, or two or more kinds of (meth)acrylic acid alkyl ester may be used. In the present embodiment, at least one substance selected from the group consisting of n-butyl acrylate, 2-ethylhexyl acrylate, and isostearyl acrylate is preferably used as (meth)acrylic acid alkyl ester for the acrylic polymer.

The content of the monomer unit derived from alkyl (meth)acrylate in the acrylic polymer is, for example, 50% by weight or more, preferably 60% by weight or more, more preferably 70% by weight or more, more preferably 80% or more, and more preferably 90% by weight or more. That is, the content of the (meth)acrylic acid alkyl ester in the monomer component composition of the raw material for constituting the acrylic polymer is, for example, 50% by weight or more, preferably 60% by weight or more, more preferably 70% by weight or more, more preferably 80% by weight or more, and even more preferably 90 wt % or more. The acrylic polymer has a monomer unit structure derived from a monomer component composition with such alkyl (meth)acrylate content. Such configuration concerning the (meth)acrylic acid alkyl ester content is suitable for appropriately expressing basic properties such as adhesiveness of the acrylic adhesive in the adhesive layer 11 and/or the adhesive layer 12.

The acrylic polymer contained in the adhesive layer 11 or the adhesive layer 12 may contain a monomer unit derived from an alicyclic monomer. Examples of the alicyclic monomer for forming the monomer unit of the acrylic polymer, that is, the alicyclic monomer which is the copolymerizable monomer for constituting the acrylic polymer include (meth)acrylic acid cycloalkyl ester, (meth)acrylic acid ester having a bicyclic aliphatic hydrocarbon ring, and (meth)acrylic acid ester having a tricyclic or more aliphatic hydrocarbon ring. Examples of the (meth)acrylic acid cycloalkyl ester include cyclopentyl (meth)acrylate, cyclohexyl (meth)acrylate, cycloheptyl (meth)acrylate, and cyclooctyl (meth)acrylate. Examples of the (meth)acrylic acid ester having a bicyclic aliphatic hydrocarbon ring include bornyl (meth)acrylate and isobornyl (meth)acrylate. Examples of the (meth)acrylic acid ester having a tricyclic or more aliphatic hydrocarbon ring includes dicyclopentanyl (meth) acrylate, dicyclopentanyloxyethyl (meth)acrylate, tricyclopentanyl (meth)acrylate, 1-adamantyl (meth)acrylate, 2-methyl-2-adamantyl (meth)acrylate, and 2-ethyl-2-adamantyl (meth)acrylate. As the alicyclic monomer for the acrylic polymer, one kind of alicyclic monomer may be used, or two or more kinds of alicyclic monomer may be used. In the present embodiment, as the alicyclic monomer for the acrylic polymer, at least one substance selected from the group consisting of cyclohexyl acrylate (CHA), cyclohexyl methacrylate (CHMA), isobornyl acrylate, and isobornyl methacrylate is preferably used.

The acrylic polymer contained in the adhesive layer 11 and/or the adhesive layer 12 may contain a monomer unit derived from a hydroxyl group-containing monomer. The hydroxyl group-containing monomer, in its monomer unit form, has at least one hydroxyl group. When the acrylic polymer in the adhesive layers 11, 12 contains a hydroxyl group-containing monomer unit, the adhesive layers 11, 12 tend to have enough adhesiveness and appropriate cohesive force.

Examples of the hydroxyl group-containing monomer for forming a monomer unit of the acrylic polymer, that is, the hydroxyl group-containing monomer which is a copolymerizable monomer for constituting the acrylic polymer include hydroxyl group-containing (meth)acrylate esters, vinyl alcohol, and allyl alcohol. Examples of the hydroxyl group-containing (meth)acrylate ester include 2-hydroxyethyl (meth)acrylate, 2-hydroxypropyl (meth)acrylate, 3-hydroxypropyl (meth)acrylate, 4-hydroxybutyl (meth)acrylate, 6-hydroxyhexyl (meth) acrylate, hydroxyoctyl (meth) acrylate, hydroxydecyl (meth)acrylate, hydroxylauryl (meth)acrylate, and (4-hydroxymethylcyclohexyl) (meth)acrylate. As the hydroxyl group-containing monomer for the acrylic polymer, one kind of hydroxyl group-containing monomer may be used, or two or more kinds of hydroxyl group-containing monomers may be used. In the present embodiment, at least one substance selected from the group consisting of 2-hydroxyethyl acrylate, 2-hydroxyethyl methacrylate, 2-hydroxypropyl acrylate, 2-hydroxypropyl methacrylate, 4-hydroxybutyl acrylate and 4-hydroxybutyl methacrylate is preferably used as the hydroxyl group-containing monomer for the acrylic polymer.

The content of the monomer unit derived from the hydroxyl group-containing monomer in the acrylic polymer is, for example, 1% by weight or more, more preferably 2% by weight or more, more preferably 3% by weight or more, more preferably 5%, more preferably 7% by weight or more, and more preferably 10% by weight or more. The content is, for example, 20% by weight or less, preferably 18% by weight or less. When the content is 1 to 20% by weight, the adhesive layers 11, 12 tend to have enough adhesiveness and appropriate cohesive force.

The acrylic polymer contained in the adhesive layer 11 and/or the adhesive layer 12 may contain a monomer unit derived from a nitrogen atom-containing monomer. The nitrogen atom-containing monomer, in its monomer unit form, has at least one nitrogen atom. When the acrylic polymer in the adhesive layers 11, 12 contains a nitrogen atom-containing monomer unit, the adhesive layers 11, 12 tend to have enough hardness and good adhesion reliability.

Examples of the nitrogen atom-containing monomer for forming the monomer unit of the acrylic polymer, that is, the nitrogen atom-containing monomer which is a copolymerizable monomer for constituting the acrylic polymer include N-vinyl cyclic amides and (meth)acrylamides. Examples of the N-vinyl cyclic amide which is a nitrogen atom-containing monomer include N-vinyl-2-pyrrolidone, N-vinyl-2-piperidone, N-vinyl-3-morpholinone, N-vinyl-2-caprolactam, N-vinyl-1,3-oxazin-2-one, and N-vinyl-3,5-morpholinedione. Examples of (meth)acrylamides which are nitrogen atom-containing monomers include (meth)acrylamide, N-ethyl (meth)acrylamide, N-isopropyl (meth)acrylamide, N-n-butyl (meth)acrylamide, N-octyl (meth)acrylamide, N,N-dimethyl (meth)acrylamide, N,N-diethyl (meth)acrylamide, N,N-dipropyl (meth)acrylamide, and N,N-diisopropyl (meth)acrylamide. As the nitrogen atom-containing monomer for the acrylic polymer, one kind of nitrogen atom-containing monomer may be used, or two or more kinds of nitrogen atom-containing monomers may be used. In the present embodiment, N-vinyl-2-pyrrolidone is preferably used as the nitrogen atom-containing monomer for the acrylic polymer.

The content of the monomer unit derived from the nitrogen atom-containing monomer in the acrylic polymer is preferably 1% by weight or more, more preferably 3 wt % or more, and more preferably 5 wt % or more from the viewpoint of imparting appropriate hardness, adhesiveness and transparency to the adhesive layers 11, 12. The content is preferably 30% by weight or less, and more preferably 25% by weight or less from the viewpoint of imparting sufficient transparency to the adhesive layers 11, 12 and the viewpoint of suppressing excessively hardening of the adhesive layers 11, 12 to impart good adhesion reliability to the adhesive layers 11, 12.

Examples of the above mentioned polyfunctional (meth)acrylate as a copolymerizable crosslinking agent contained in the acrylic adhesive composition for forming the adhesive layer 11 and/or the adhesive layer 12 include 1,6-hexanediol di(meth)acrylate, butanediol di(meth)acrylate, (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylates, and urethane acrylates. As the polyfunctional (meth)acrylate, one kind of polyfunctional (meth)acrylate may be used, or two or more kinds of polyfunctional (meth)acrylates may be used. In the present embodiment, the polyfunctional (meth)acrylate for the acrylic polymer is preferably at least one substance selected from the group consisting of 1,6-hexanediol diacrylate, dipentaerythritol hexaacrylate, and trimethylolpropane triacrylate.

The content of the polyfunctional (meth)acrylate-derived monomer unit in the acrylic polymer is, for example, 0.01% by weight or more, preferably 0.03% by weight or more, and more preferably 0.05% by weight or more, from the viewpoint of imparting appropriate hardness and adhesiveness to the adhesive layers 11, 12. The content is, for example, 1% by weight or less, preferably 0.5% by weight or less from the viewpoint of imparting appropriate hardness and adhesiveness to the adhesive layers 11, 12.

The acrylic polymer can be obtained by polymerizing raw material monomer components. The polymerization methods include, for example, solution polymerization, emulsion polymerization, and bulk polymerization. In solution polymerization, solvents such as aromatic hydrocarbons, aliphatic hydrocarbons, alicyclic hydrocarbons, esters, and ketones can be used. Examples of aromatic hydrocarbon solvents include, for example, toluene and benzene. Examples of aliphatic hydrocarbon solvents include n-hexane and n-heptane. Examples of alicyclic hydrocarbon solvents include cyclohexane and methylcyclohexane. Examples of ester solvents include ethyl acetate and n-butyl acetate. Examples of ketone solvents include methyl ethyl ketone and methyl isobutyl ketone. In solution polymerization, one type of solvent may be used, or two or more types of solvents may be used.

In order to obtain an acrylic polymer by polymerizing raw material monomer components, a polymerization initiator can be used. Depending on the type of polymerization reaction, for example, a photopolymerization initiator or a thermal polymerization initiator can be used. For polymerization, one type of polymerization initiator may be used, or two or more types of polymerization initiators may be used.

Examples of the photopolymerization initiators include benzoin ether photoinitiators, acetophenone photoinitiators, α-ketol photoinitiators, aromatic sulfonyl chloride photoinitiators, photoactive oxime photoinitiators, benzoin photoinitiators, benzyl photoinitiators, benzophenone photoinitiators, ketal photoinitiators, and thioxanthone photoinitiators. Examples of the benzoin ether photoinitiators include benzoin methyl ether, benzoin ethyl ether, benzoin propyl ether, benzoin isopropyl ether, benzoin isobutyl ether, and 2,2-dimethoxy-1,2-diphenylethan-1-one. Examples of the acetophenone photoinitiators include 2,2-diethoxyacetophenone, 2,2-dimethoxy-2-phenylacetophenone, 1-hydroxycyclohexyl phenyl ketone (α-hydroxycyclohexyl phenyl ketone), 4-phenoxydichloroacetophenone, and 4-(t-butyl)dichloroacetophenone. Examples of the α-ketol photoinitiators include 2-methyl-2-hydroxypropiophenone and 1-[4-(2-hydroxyethyl)phenyl]-2-methylpropan-1-one. Examples of the aromatic sulfonyl chloride photoinitiators include 2-naphthalenesulfonyl chloride. Examples of the photoactive oxime photoinitiators include 1-phenyl-1,1-propanedione-2-(O-ethoxycarbonyl)-oxime. Examples of the benzoin photoinitiators include benzoin. Examples of the benzil photoinitiators include benzil. Examples of the benzophenone photoinitiators include benzophenone, benzoylbenzoic acid, 3,3″-dimethyl-4-methoxybenzophenone, and polyvinylbenzophenones. Examples of the ketal photoinitiators include benzyl dimethyl ketal. Examples of the thioxanthone photoinitiators include thioxanthone, 2-chlorothioxanthone, 2-methylthioxanthone, 2,4-dimethylthioxanthone, isopropylthioxanthone, 2,4-diisopropylthioxanthone, and dodecylthioxanthone. The amount of the photopolymerization initiator used is, for example, 0.01 to 3 parts by weight based on the total amount (100 parts by weight) of the monomer components.

Examples of the thermal initiators include azo polymerization initiators, peroxide polymerization initiators, and redox polymerization initiators. Examples of the azo polymerization initiators include 2,2″-azobisisobutyronitrile, 2,2″-azobis-2-methylbutyronitrile, dimethyl 2,2″-azobis(2-methylpropionate), and 4,4″-azobis-4-cyanovaleric acid. Examples of peroxide polymerization initiators include dibenzoyl peroxide and tert-butyl permaleate. The amount of the thermal polymerization initiator used is, for example, 0.05 to 0.3 parts by weight based on the total amount (100 parts by weight) of the monomer components.

In the polymerization for obtaining the acrylic polymer, a chain transfer agent can be used for adjusting the molecular weight of the acrylic polymer. Examples of the chain transfer agent include α-thioglycerol, 2-mercaptoethanol, 2,3-dimercapto-1-propanol, octyl mercaptan, t-nonyl mercaptan, dodecyl mercaptan (lauryl mercaptan), t-dodecyl mercaptan, glycidyl mercaptan, thioglycolic acid, methyl thioglycolate, ethyl thioglycolate, propyl thioglycolate, butyl thioglycolate, t-butyl thioglycolate, octyl thioglycolate, 2-ethylhexyl thioglycolate, isooctyl thioglycolate, decyl thioglycolate, and dodecyl thioglycolate. As the chain transfer agent, one kind of chain transfer agent may be used, or two or more kindsof chain transfer agents may be used. In the present embodiment, α-thioglycerol is preferably used as the chain transfer agent. The amount of the chain transfer agent used is, for example, 0.01 to 0.5 parts by weight based on the total amount (100 parts by weight) of the monomer components for obtaining the acrylic polymer.

The content of the acrylic polymer as described above in the adhesive layer (adhesive layer 11 and/or adhesive layer 12) is, for example, 85 to 100% by weight.

The acrylic adhesive composition for forming the adhesive layer 11 and/or the adhesive layer 12 may contain an oligomer from the viewpoint of improving the adhesiveness of each adhesive layer, for example, at room temperature. The oligomer is a polymer whose monomer unit composition is inconsistent with the above-mentioned acrylic polymer and the partially polymerized substance described above.

The above-mentioned oligomer preferably contains a monomer unit derived from a (meth)acrylic acid ester (ring-containing (meth)acrylic acid ester) having a cyclic structure in the molecule, and a monomer unit derived from an alkyl (meth)acrylate ester having a linear or branched alkyl group.

Examples of the ring-containing (meth)acrylic acid ester for forming the monomer unit of the oligomer, that is, the ring-containing (meth)acrylic acid ester for constituting the oligomer include cycloalkyl (meth)acrylic esters, (meth)acrylic acid esters having a bicyclic hydrocarbon ring, (meth)acrylic acid esters having a tricyclic or more aliphatic hydrocarbon ring, and (meth)acrylic acid esters having an aromatic ring. The cycloalkyl (meth)acrylic acid esters include, for example, cyclopentyl (meth) acrylate, cyclohexyl (meth) acrylate, cycloheptyl (meth)acrylate, and cyclooctyl (meth)acrylate. Examples of the (meth)acrylic acid ester having a bicyclic hydrocarbon ring include bornyl (meth)acrylate and isobornyl (meth)acrylate. Examples of (meth)acrylic acid esters having a tricyclic or more aliphatic hydrocarbon ring include dicyclopentanyl (meth)acrylate, dicyclopentanyloxyethyl (meth) acrylate, tricyclopentanyl (meth)acrylate, 1-adamantyl (meth)acrylate, 2-methyl-2-adamantyl (meth)acrylate, and 2-ethyl-2-adamantyl (meth)acrylate. Examples of the (meth)acrylic acid ester having an aromatic ring include phenyl (meth)acrylate, phenoxyethyl (meth)acrylate, and benzyl (meth)acrylate. As the ring-containing (meth)acrylic acid ester for the above oligomer, one kind of ring-containing (meth)acrylic acid ester may be used, or two or more kinds of ring-containing (meth)acrylic acid esters may be used. In the present embodiment, at least one substance selected from the group consisting of dicyclopentanyl methacrylate and dicyclopentanyl acrylate is preferably used as the ring-containing (meth)acrylic acid ester for the oligomer.

The content of the monomer unit derived from the ring-containing (meth)acrylic acid ester in the oligomer is, for example, 10 to 90% by weight, preferably 20 to 80% by weight, and more preferably 35 to 80% by weight based on the total amount (100% by weight) of the monomer components for forming the oligomer, from the viewpoint of imparting appropriate flexibility to the adhesive layer formed from the acrylic adhesive composition containing the oligomer.

Examples of (meth)acrylic acid alkyl ester having a linear or branched alkyl group for forming the monomer unit of the oligomer, that is, a monomer for constituting the oligomer include (meth)acrylic acid alkyl esters having a linear or branched alkyl group having 1 to 20 carbon atoms. Examples of these (meth)acrylic acid alkyl esters include methyl (meth)acrylate, ethyl (meth)acrylate, propyl (meth)acrylate, isopropyl (meth)acrylate, n-butyl (meth)acrylate, s-butyl (meth)acrylate, isobutyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth) acrylate, hexadecyl (meth) acrylate, heptadecyl (meth) acrylate, octadecyl (meth) acrylate, isostearyl (meth)acrylate, nonadecyl (meth)acrylate, and eicosyl (meth)acrylate. As the (meth)acrylic acid alkyl ester for the above oligomer, one kind of alkyl (meth)acrylate ester may be used, or two or more kinds of (meth)acrylic acid alkyl esters may be used. In the present embodiment, methyl methacrylate is preferably used as the (meth)acrylic acid alkyl ester for the oligomer.

The content of the monomer unit derived from the (meth)acrylic acid alkyl ester having a linear or branched alkyl group in the above-mentioned oligomer is, for example, 10 to 90% by weight, preferably 20 to 80% by weight, and more preferably 20 to 60% by weight based on the total amount (100% by weight) of the monomer components for forming the oligomer, from the viewpoint of imparting an appropriate elastic modulus to the adhesive layer formed from the acrylic adhesive composition containing the oligomer.

Also, the above oligomer may contain one or more monomer units derived from carboxy group-containing monomers, amide group-containing monomers, amino group-containing monomers, cyano group-containing monomers, sulfonate group-containing monomers, phosphate group-containing monomers, isocyanate group-containing monomers or imide group-containing monomers.

The oligomer can be obtained by polymerizing raw material monomer components. The polymerization method includes, for example, solution polymerization, emulsion polymerization, and bulk polymerization. Solvents that can be used in solution polymerization include those described above as solvents that can be used in solution polymerization to obtain acrylic polymers. In the solution polymerization, one type of solvent may be used, or two or more types of solvents may be used. In order to obtain the above oligomer, a polymerization initiator can be used for polymerizing raw material monomer components. Depending on the type of polymerization reaction, for example, a photoinitiator or a thermal initiator can be used. Examples of the photoinitiators and thermal initiators for obtaining the oligomer include those described above as photoinitiators and thermal polymerization initiators for obtaining an acrylic polymer. In the polymerization, one type of polymerization initiator may be used, or two or more types of polymerization initiators may be used.

The oligomer has a weight average molecular weight (Mw) of, for example, 1000 to 30000, preferably 1000 to 20000, and more preferably 1500 to 10000. From the viewpoint of securing a good adhesive strength of the adhesive layer formed from the acrylic adhesive composition containing the oligomer, it is preferable that the oligomer has a weight average molecular weight of 1,000 or more. On the other hand, it is preferable that the oligomer has a weight average molecular weight of 30000 or less from the viewpoint of ensuring the adhesive strength, particularly at room temperature, of the adhesive layer formed from the acrylic adhesive composition containing the oligomer.

The weight average molecular weight of the oligomer can be measured by a gel permeation chromatography (GPC). For example, the weight average molecular weight (Mw) can be obtained as a value in terms of standard polystyrene under the following measurement conditions using a GPC measuring apparatus (trade name “HLC-8120 GPC,” manufactured by Tosoh Corporation).
Column: TSKgel Super AWM-H (upstream side, manufactured by Tosoh Corporation) and TSKgel Super AW 4000 (manufactured by Tosoh Corporation) and TSKgel Super AW 2500 (downstream side, manufactured by Tosoh Corporation), tandemly connected
Column size: 6.0 mmp×150 mm for each column
Column temperature (measurement temperature): 40° C.
Eluent: tetrahydrofuran (THF)
Flow rate: 0.4 mL/min
Sample injection amount: 20 μL
Sample concentration: about 2.0 g/L (tetrahydrofuran solution)
Standard sample: polystyrene
Detector: differential refractometer (RI)

The content of the oligomer as described above in the adhesive layer (adhesive layer 11 and/or adhesive layer 12) is, for example, 0 to 20 parts by weight based on 100 parts by weight of the acrylic polymer in the adhesive layer.

The above acrylic adhesive composition for forming the adhesive layer 11 and/or the adhesive layer 12, and thus the adhesive layer 11 and/or adhesive layer 12, may contain an ultraviolet absorber. An ultraviolet absorber is a chemical species capable of efficiently absorbing ultraviolet rays and releasing absorbed energy by changing it into heat or infrared rays. Examples of such ultraviolet absorbers include benzotriazole ultraviolet absorbers, hydroxyphenyl triazine ultraviolet absorbers, salicylic acid ester ultraviolet absorbers, benzophenone ultraviolet absorbers, oxybenzophenone ultraviolet absorbers, and cyanoacrylate type ultraviolet absorbers. The acrylic adhesive composition may contain one type of ultraviolet absorber or may contain two or more types of ultraviolet absorbers.

Examples of the benzotriazole ultraviolet absorbers include 2-(2-hydroxy-5-tert-butylphenyl)-2H-benzotriazole (e.g., trade name Tinuvin PS, supplied by BASF SE); 3-(2H-benzotriazol-2-yl)-5-(1,1-dimethylethyl)-4-hydroxy-benzenepropanoic acid, C₇-C₉-branched and linear alkyl esters (e.g., trade name Tinuvin 384-2, supplied by BASF SE); mixtures of octyl 3-[3-tert-butyl-4-hydroxy-5-(5-chloro-2H-benzotriazol-2-yl)phenyl]propionate and 2-ethylhexyl-3-[3-tert-butyl-4-hydroxy-5-(5-chloro-2H-benzotriazol-2-yl)phenyl]propionate (e.g., trade name Tinuvin 109, supplied by BASF SE); 2-(2H-benzotriazol-2-yl)-4,6-bis(1-methyl-1-phenylethyl)phenol (e.g., trade name Tinuvin 900, supplied by BASF SE); 2-(2H-benzotriazol-2-yl)-6-(1-methyl-1-phenylethyl)-4-(1,1,3,3-tetramethylbutyl)phenol (e.g., trade name Tinuvin 928, supplied by BASF SE); reaction products of methyl 3-(3-(2H-benzotriazol-2-yl)-5-tert-butyl-4-hydroxyphenyl)propionate with poly(ethylene glycol) 300 (e.g., trade names Tinuvin 1130, supplied by BASF SE); 2-(2H-benzotriazol-2-yl)-p-cresol (e.g., trade name Tinuvin P, supplied by BASF SE); 2-(2H-benzotriazol-2-yl)-4,6-bis(1-methyl-1-phenylethyl)phenol (e.g., trade name Tinuvin 234, supplied by BASF SE); 2-[5-chloro-2H-benzotriazol-2-yl]-4-methyl-6-(tert-butyl)phenol (e.g., trade name Tinuvin 326, supplied by BASF SE); 2-(2H-benzotriazol-2-yl)-4,6-di-tert-pentylphenol (e.g., trade name Tinuvin 328, supplied by BASF SE); 2-(2H-benzotriazol-2-yl)-4-(1,1,3,3-tetramethylbutyl)phenol (e.g., trade name Tinuvin 329, supplied by BASF SE); 2,2′-methylenebis[6-(2H-benzotriazol-2-yl)-4-(1,1,3,3-tetramethylbutyl)phenol] (e.g., trade name Tinuvin 360, supplied by BASF SE); 2-(2H-benzotriazol-2-yl)-6-dodecyl-4-methylphenol (e.g., trade name Tinuvin 571, supplied by BASF SE); 2-[2-hydroxy-3-(3,4,5,6-tetrahydrophthalimido-methyl)-5-methylphenyl]benzotriazole (e.g., trade name Sumisorb 250, supplied by Sumitomo Chemical Co., Ltd.); and 2,2′-methylenebis[6-(2H-benzotriazol-2-yl)-4-tert-octylphenol] (e.g., trade name ADK STAB LA-31, supplied by ADEKA CORPORATION).

Examples of the hydroxyphenyltriazine ultraviolet absorbers (hydroxyphenyltriazine compounds) include reaction products of 2-(4,6-bis(2,4-dimethylphenyl)-1,3,5-triazin-2-yl)-5-hydroxyphenyl with [(C₁₀-C₁₆ alkyloxy)methyl]oxirane (e.g., trade name Tinuvin 400, supplied by BASF SE); 2-[4,6-bis(2,4-dimethylphenyl)-1,3,5-triazin-2-yl]-5-[3-(dodecyloxy)-2-hydroxypropoxy]phenol); reaction products of 2-(2,4-dihydroxyphenyl)-4,6-bis-(2,4-dimethylphenyl)-1,3,5-triazine with (2-ethylhexyl) glycidate (e.g., trade name Tinuvin 405, supplied by BASF SE); 2,4-bis(2-hydroxy-4-butoxyphenyl)-6-(2,4-dibutoxyphenyl)-1,3,5-triazine (e.g., trade name Tinuvin 460, supplied by BASF SE); 2-(4,6-diphenyl-1,3,5-triazin-2-yl)-5-[(hexyl)oxy]-phenol (e.g., trade name Tinuvin 1577, supplied by BASF SE); 2-(4,6-diphenyl-1,3,5-triazin-2-yl)-5-[2-(2-ethylhexanoyloxy)ethoxy]-phenol (e.g., trade name ADK STAB LA-46, supplied by ADEKA CORPORATION); and 2-(2-hydroxy-4-[1-octyloxycarbonylethoxy]phenyl)-4,6-bis(4-phenylphenyl)-1,3,5-triazine (e.g., trade name Tinuvin 479, supplied by BASF SE).

Examples of the salicylic acid ester ultraviolet absorbers (salicylic acid ester compounds) include phenyl 2-acryloyloxybenzoate, phenyl 2-acryloyloxy-3-methylbenzoate, phenyl 2-acryloyloxy-4-methylbenzoate, phenyl 2-acryloyloxy-5-methylbenzoate, phenyl 2-acryloyloxy-3-methoxybenzoate, phenyl 2-hydroxybenzoate, phenyl 2-hydroxy-3-methylbenzoate, phenyl 2-hydroxy-4-methylbenzoate, phenyl 2-hydroxy-5-methylbenzoate, phenyl 2-hydroxy-3-methoxybenzoate and 2,4-di-tert-butylphenyl 3,5-di-tert-butyl-4-hydroxybenzoate (e.g., trade name Tinuvin 120, supplied by BASF SE).

Examples of the benzophenone ultraviolet absorbers (benzophenone compounds) and oxybenzophenone ultraviolet absorbers (oxybenzophenone compounds)include 2,4-dihydroxybenzophenone, 2-hydroxy-4-methoxybenzophenone, 2-hydroxy-4-methoxybenzophenone-5-sulfonic acid, 2-hydroxy-4-octyloxybenzophenone, 4-dodecyloxy-2-hydroxybenzophenone, 4-benzyloxy-2-hydroxybenzophenone, 2,2′-dihydroxy-4-methoxybenzophenone (e.g., trade name KEMISORB 111, supplied by Chemipro Kasei Kaisha, Ltd.), 2,2′,4,4′-tetrahydroxybenzophenone (e.g., trade name SEESORB 106, supplied by Shipro Kasei Kaisha, Ltd.) and 2,2′-dihydroxy-4,4′-dimethoxybenzophenone.

Examples of the cyanoacrylate ultraviolet absorbers (cyanoacrylate compounds) include alkyl 2-cyanoacrylates, cycloalkyl 2-cyanoacrylates, alkoxyalkyl 2-cyanoacrylates, alkenyl 2-cyanoacrylates, and alkynyl 2-cyanoacrylates.

The ultraviolet absorber is preferably at least one substance selected from the group consisting of a benzotriazole ultraviolet absorber, a hydroxyphenyl triazine ultraviolet absorber, and a benzophenone ultraviolet absorber, from the viewpoint that the ultraviolet absorber contained in the adhesive layer 11 and/or the adhesive layer 12 should have high ultraviolet absorptivity and high photostability and from the viewpoint that the ultraviolet absorber should be suitable for obtaining a highly transparent adhesive layer. More preferably, the ultraviolet absorber is a benzotriazole ultraviolet absorber. Particularly preferably, the ultraviolet absorber is a benzotriazole ultraviolet absorber having a hydrocarbon group of 6 or more carbon atoms and a phenyl group having a hydroxyl group as a substituent, where the phenyl group is bonded to a nitrogen atom constituting the benzotriazole ring.

In the case where the adhesive layer 11 and/or the adhesive layer 12 contains an ultraviolet absorber, the content of the ultraviolet absorber in the adhesive layer is preferably 0.01 parts by weight or more, more preferably 0.05 parts by weight or more, and more preferably 0.1 parts by weight or more with respect to 100 parts by weight of the acrylic polymer in the adhesive layer, from the viewpoint of controlling transmittance of light with a wavelength of 350 nm in the adhesive layer to impart high ultraviolet absorptivity to the adhesive layer. The content of the ultraviolet absorber in the adhesive layer is preferably 10 parts by weight or less, more preferably 9 parts by weight or less, and more preferably 8 parts by weight or less with respect to 100 parts by weight of the acrylic polymer in the adhesive layer, from the viewpoint of suppressing yellowing phenomenon of the adhesive due to the ultraviolet absorber to obtain excellent optical characteristics and high transparency of the adhesive layer.

The above-mentioned acrylic adhesive composition for forming the adhesive layer 11 and/or the adhesive layer 12, and therefore the adhesive layer 11 and/or the adhesive layer 12, may contain a photostabilizer. When the acrylic adhesive composition contains a light stabilizer, it preferably also contains an ultraviolet absorber. The light stabilizer is for trapping radicals that can be generated by irradiation of light such as ultraviolet rays. The configuration that the adhesive layer 11 and/or the adhesive layer 12 contains a light stabilizer is suitable for imparting high light resistance to the formed adhesive layer. The acrylic adhesive composition may contain one type of light stabilizer or two or more types of light stabilizers.

Examples of the photostabilizer include phenolic photostabilizers, phosphorus photostabilizers, thioether photostabilizers and amine photostabilizers, such as hindered amine stabilizers.

Examples of the phenolic photostabilizers include 2,6-di-tert-butyl-4-methylphenol, 4-hydroxymethyl-2,6-di-tert-butylphenol, 2,6-di-tert-butyl-4-ethylphenol, butylated hydroxyanisole, n-octadecyl 3-(4-hydroxy-3,5-di-tert-butylphenyl)propionate, distearyl (4-hydroxy-3-methyl-5-tert-butyl)benzylmalonate, tocopherol, 2,2′-methylenebis(4-methyl-6-tert-butylphenol), 2,2′-methylenebis(4-ethyl-6-tert-butylphenol), 4,4′-methylenebis(2,6-di-tert-butylphenol), 4,4′-butylidenebis(6-tert-butyl-m-cresol), 4,4′-thiobis(6-tert-butyl-m-cresol), styrenated phenol, N,N′-hexamethylenebis(3,5-di-tert-butyl-4-hydroxyhydrocinnamide, calcium bis[ethyl(3,5-di-tert-butyl-4-hydroxybenzyl)phosphonate], 1,1,3-tris(2-methyl-4-hydroxy-5-tert-butylphenyl)butane, 1,3,5-trimethyl-2,4,6-tris(3,5-di-tert-butyl-4-hydroxybenzyl)benzene, tetrakis[3-(3,5-di-tert-butyl-4-hydroxyphenyl)propionyloxymethyl]methane, 1,6-hexanediol bis[3-(3,5-di-tert-butyl-4-hydroxyphenyl)propionate], 2,2′-methylenebis(4-methyl-6-cyclohexylphenol), 2,2′-methylenebis[6-(1-methylcyclohexyl)-p-cresol], 1,3,5-tris(4-tert-butyl-3-hydroxy-2,6-dimethylbenzyl) isocyanurate, 1,3,5-tris(3,5-di-tert-butyl-4-hydroxybenzyl) isocyanurate, triethylene glycol bis[3-(3-tert-butyl-4-hydroxy-5-methylphenyl) propionate], 2,2′-oxamidobis[ethyl 3-(3,5-di-tert-butyl-4-hydroxyphenyl)propionate], 6-(4-hydroxy-3,5-di-tert-butylanilino)-2,4-dioctylthio-1,3,5-triazine, bis[2-tert-butyl-4-methyl-6-(2-hydroxy-3-tert-butyl-5-methylbenzyl)phenyl] terephthalate, 3,9-bis(2-[3-(3-tert-butyl-4-hydroxy-5-methylphenyl)propionyloxy]-1,1-dimethylethyl)-2,4,8,10-tetraoxaspiro[5.5]undecane and 3,9-bis(2-[3-(3,5-di-tert-butyl-4-hydroxyphenyl)propionyloxy]-1,1-dimethylethyl)-2,4,8,10-tetraoxaspiro[5.5]undecane.

Examples of the phosphorus photostabilizers include tris(nonylphenyl) phosphite, tris(2,4-di-tert-butylphenyl) phosphite, tris[2-tert-butyl-4-(3-tert-butyl-4-hydroxy-5-methylphenylthio)-5-methylphenyl] phosphite, tridecyl phosphite, octyl diphenyl phosphite, didecyl monophenyl phosphite, bis(tridecyl)pentaerythritol diphosphite, distearylpentaerythritol diphosphite, bis(nonylphenyl)pentaerythritol diphosphite, bis(2,4-di-tert-butylphenyl)pentaerythritol diphosphite, bis(2,6-di-tert-butyl-4-methylphenyl)pentaerythritol diphosphite, bis(2,4,6-tri-tert-butylphenyl)pentaerythritol diphosphite, tetra(tridecyl)isopropylidenediphenol diphosphite, tetra(tridecyl)-4,4′-n-butylidenebis(2-tert-butyl-5-methylphenol) diphosphite, hexa(tridecyl)-1,1,3-tris(2-methyl-4-hydroxy-5-tert-butylphenyl)butane triphosphite, tetrakis(2,4-di-tert-butylphenyl)biphenylene diphosphonite, 9,10-dihydro-9-oxa-10-phosphaphenanthrene-10-oxide, and tris(2-[(2,4,8,10-tetrakis-tert-butyldibenzo[d,f][1,3,2]dioxaphosphepin-6-yl)oxy]ethyl)amine.

Examples of the thioether photostabilizers include dialkyl thiodipropionate compounds, such as dilauryl thiodipropionate, dimyristyl thiodipropionate and distearyl thiodipropionate; and β-alkylmercaptopropionic acid esters of polyols, such as tetrakis[methylene-(3-dodecylthio)propionate]methane.

Examples of the amine photostabilizers include a polymerized product of 4-hydroxy-2,2,6,6-tetramethyl-1-piperidineethanol with dimethyl succinate (e.g., trade name Tinuvin 622, supplied by BASF SE); a 1:1 reaction product of N,N′,N″,N″'-tetrakis-(4,6-bis-(butyl-(N-methyl-2,2,6,6-tetramethylpiperidin-4-yl)amino)-triazin-2-yl)-4,7-diazadecane-1,10-diamine and a polymerized product of 4-hydroxy-2,2,6,6-tetramethyl-1-piperidineethanol with dimethyl succinate (e.g., trade name Tinuvin 119, supplied by BASF SE); poly[[6-[(1,1,3,3-tetramethylbutyl)amino]-1,3,5-triazine-2,4-diyl][(2,2,6,6-tetramethyl-4-piperidinyl)imino]hexamethylene[(2,2,6,6-tetramethyl-4-piperidinyl)imino]] (e.g., trade name Tinuvin 944, supplied by BASF SE); bis(2,2,6,6-tetramethyl-4-piperidyl) sebacate (e.g., trade name Tinuvin 770, supplied by BASF SE); reaction products of decanedioic acid bis(2,2,6,6-tetramethyl-1-(octyloxy)-4-piperidinyl) ester, 1,1-dimethylethyl hydroperoxide, and octane (e.g., trade name Tinuvin 123, supplied by BASF SE); bis(1,2,2,6,6-pentamethyl-4-piperidyl)[[3,5-bis(1,1-dimethylethyl)-4-hydroxyphenyl]methyl]butylmalonate (e.g., trade name Tinuvin 144, supplied by BASF SE); reaction products of: reaction products of peroxy-N-butyl-2,2,6,6-tetramethyl-4-piperidinamine-2,4,6-trichloro-1,3,5-triazine and cyclohexane, with 2-aminoethanol (e.g., trade name Tinuvin 152, supplied by BASF SE); mixtures of bis(1,2,2,6,6-pentamethyl-4-piperidyl) sebacate and methyl 1,2,2,6,6-pentamethyl-4-piperidyl sebacate (e.g., trade name Tinuvin 292, supplied by BASF SE); and reaction products (mixed esterified products) of 1,2,3,4-butanetetracarboxylic acid with1,2,2,6,6-pentamethyl-4-piperidinol and 3,9-bis(2-hydroxy-1,1-dimethylethyl)-2,4,8,10-tetraoxaspiro[5.5]undecane (e.g., trade name ADK STAB LA-63P, supplied by ADEKA CORPORATION). Of the amine stabilizers, hindered amine stabilizers are particularly preferred.

In the case where the adhesive layer 11 and/or the adhesive layer 12 contains a light stabilizer, the content of the light stabilizer in the adhesive layer is preferably 0.1 parts by weight or more, and more preferably 0.2 parts by weight with respect to 100 parts by weight of the acrylic polymer in the adhesive layer from the viewpoint of imparting sufficient light resistance to the adhesive layer. The content of the light stabilizer in the adhesive layer is preferably 5 parts by weight or less, and more preferably 3 parts by weight or less with respect to 100 parts by weight of the acrylic polymer in the adhesive layer from the viewpoint of suppressing coloring of the adhesive layer due to the light stabilizer to obtain high transparency of the adhesive layer.

The acrylic adhesive composition for forming the adhesive layer 11 and/or the adhesive layer 12, and thus the adhesive layer 11 and/or the adhesive layer 12, may contain a crosslinking agent for crosslinking between acrylic polymers. Adjustment of the crosslinking reaction by the crosslinking agent between the acrylic polymers is a method of controlling the gel fraction of the adhesive layer 11 and/or the adhesive layer 12. The acrylic adhesive composition may contain one type of the crosslinking agent or may contain two or more types of the crosslinking agents.

Examples of the crosslinking agents include isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Among them, isocyanate crosslinking agents and epoxy crosslinking agents are preferred.

Examples of the isocyanate crosslinking agents include lower aliphatic polyisocyanates, alicyclic polyisocyanates, and aromatic polyisocyanates. Examples of the lower aliphatic polyisocyanates include 1,2-ethylene diisocyanate, 1,4-butylene diisocyanate, and 1,6-hexamethylene diisocyanate. Examples of the alicyclic polyisocyanates include cyclopentylene diisocyanates, cyclohexylene diisocyanates, isophorone diisocyanate, hydrogenated tolylene diisocyanates, and hydrogenated xylene diisocyanates. Examples of the aromatic polyisocyanates include 2,4-tolylene diisocyanate, 2,6-tolylene diisocyanate, 4,4′-diphenylmethane diisocyanate, and xylylene diisocyanates. Examples of the isocyanate crosslinking agents also include commercial products such as trimethylolpropane/tolylene diisocyanate adduct (e.g., trade name CORONATE L, supplied by Nippon Polyurethane Industry Co., Ltd.), trimethylolpropane/hexamethylene diisocyanate adduct (e.g., trade name CORONATE HL, supplied by Nippon Polyurethane Industry Co., Ltd.), and trimethylolpropane/xylylene diisocyanate adduct (e.g., trade name TAKENATE D-110N, supplied by Mitsui Chemicals Inc.).

Examples of the epoxy crosslinking agents (multifunctional epoxy compounds) include N,N,N′,N′-tetraglycidyl-m-xylenediamine, diglycidylaniline, 1,3-bis(N,N-diglycidylaminomethyl)cyclohexane, 1,6-hexanediol diglycidyl ether, neopentyl glycol diglycidyl ether, ethylene glycol diglycidyl ether, propylene glycol diglycidyl ether, poly(ethylene glycol) diglycidyl ethers, poly(propylene glycol) diglycidyl ethers, sorbitol polyglycidyl ethers, glycerol polyglycidyl ethers, pentaerythritol polyglycidyl ethers, polyglycerol polyglycidyl ethers, sorbitan polyglycidyl ethers, trimethylolpropane polyglycidyl ethers, diglycidyl adipate, diglycidyl o-phthalate, triglycidyl-tris(2-hydroxyethyl) isocyanurate, resorcinol diglycidyl ether, and bisphenol-S diglycidyl ether. Examples of the epoxy crosslinking agents also include epoxy resins containing two or more epoxy groups in the molecule. Examples of the epoxy crosslinking agents further include commercial products such as trade name TETRAD C (supplied by MITSUBISHI GAS CHEMICAL COMPANY, INC.).

When the adhesive layer 11 and/or the adhesive layer 12 contains the crosslinking agent for crosslinking between the acrylic polymers, the content of the crosslinking agent in the adhesive layer is preferably 0.001 part by weight or more, and more preferably 0.01 parts by weight or more with respect to 100 parts by weight of the acrylic polymer, from the viewpoint of imparting sufficient adhesion reliability against the adherend to the adhesive layer. The content is preferably 10 parts by weight or less, and more preferably 5 parts by weight or less with respect to 100 parts by weight of the acrylic polymer, from the viewpoint of imparting appropriate flexibility to the adhesive layer to obtain good adhesive strength.

The acrylic adhesive composition for forming the adhesive layer 11 and/or the adhesive layer 12, and therefore the adhesive layer 11 and/or the adhesive layer 12, may contain a silane coupling agent. The configuration that the adhesive layer contains a silane coupling agent is suitable for imparting high adhesiveness under humidified conditions, particularly high adhesion to glass, to the adhesive layer.

Examples of the silane coupling agent include γ-glycidoxypropyltrimethoxysilane, γ-glycidoxypropyltriethoxysilane, γ-aminopropyltrimethoxysilane, and N-phenyl-aminopropyltrimethoxysilane. Examples of the silane coupling agent also include commercial products such as trade name KBM-403 (supplied by Shin-Etsu Chemical Co., Ltd.). Of the silane coupling agents, y-glycidoxypropyltrimethoxysilane is preferred.

When the adhesive layer 11 and/or the adhesive layer 12 contains a silane coupling agent, the content of the silane coupling agent in the adhesive layer is preferably 0.01 part by weight or more, and more preferably 0.02 parts by weight or more with respect to 100 parts by weight of the acrylic polymer. The content of the silane coupling agent in the adhesive layer is preferably 1 part by weight or less, and more preferably 0.5 part by weight or less with respect to 100 parts by weight of the acrylic polymer.

Each of the adhesive layers 11, 12 may further contain other additive, if necessary, as long as the effects of the present invention are not impaired. Examples of the additive include crosslinking accelerators, tackifying resins, antiaging agents, fillers, colorants including pigments and dyes, antioxidants, chain transfer agents, plasticizers, softeners, surfactants, and antistatic agents. Examples of the tackifier resins include rosin derivatives, polyterpene resins, petroleum resins, and oil-soluble phenols.

The storage modulus (shear storage elastic modulus) of the adhesive layer 11 in the adhesive sheet X at 95° C., that is, the storage modulus (shear storage elastic modulus) of the constituent material of the adhesive layer 11 at 95° C. is 1.0×10⁴ Pa or more, preferably 5.0×10⁴ Pa or more, and more preferably 1.0×10⁵ Pa or more. The storage modulus of the adhesive layer 11 can be adjusted by, for example, adjusting the proportion of various monomers for constituting the acrylic polymer in the adhesive layer, adjusting the content of the copolymerizable multifunctional (meth)acrylate in the adhesive composition for forming the adhesive layer, adjusting the content of the crosslinking agent for crosslinking between the formed acrylic polymers in the composition, and setting the thickness of the adhesive composition layer or the adhesive layer during polymerization. The storage modulus can be determined from dynamic viscoelasticity measurement using, for example, a dynamic viscoelasticity measuring device (trade name “ARES,” manufactured by Rheometrics Co., Ltd.). The measurement is performed under the condition that the measurement mode is set to the shear mode, the measurement temperature range is set to, for example, −70° C. to 150° C., the heating rate is set to, for example, 5° C./min, and the frequency is set to 1 Hz, for example.

The adhesive layer 11 has a thickness of 30 μm or more, preferably 50 μm or more, and more preferably 80 μm or more. The adhesive layer 11 preferably has a thickness of 500 μm or less.

The adhesive layer 11 has a shear adhesive strength to polycarbonate of 10 N/cm² or more, preferably 15 N/cm² or more, and more preferably 20 N/cm² or more. Shear adhesive strength can be measured by the method described below in Examples.

The loss tangent (=loss elastic modulus/storage modulus) of the adhesive layer 12 in the adhesive sheet X at 95° C., that is, the loss tangent of the constituent material of the adhesive layer 12 at 95° C. is 0.08 or more, preferably 0.1 or more, more preferably 0.12 or more, and more preferably 0.15 or more. The loss tangent of the adhesive layer 12 can be adjusted by, for example, adjusting the proportion of various monomers for constituting the acrylic polymer in the adhesive layer, adjusting the content of the copolymerizable polyfunctional (meth)acrylate in the adhesive composition for forming the adhesive layer, adjusting the content of the crosslinking agent for crosslinking between the formed acrylic polymers in the composition, and adjusting the thickness of the adhesive composition layer or the adhesive layer during polymerization. The loss tangent can be obtained from, for example, dynamic viscoelasticity measurement using a dynamic viscoelasticity measuring device (trade name “ARES,” manufactured by Rheometrics Co., Ltd.). The measurement is performed under the condition that the measurement mode is a shear mode, the measurement temperature range is, for example, −70° C. to 150° C., the heating rate is, for example, 5° C./min, and the frequency is 1 Hz, for example.

The adhesive layer 12 preferably has a thickness of 100 μm or more, more preferably 150 μm or more, more preferably 200 μm or more, and even more preferably 250 μm or more. The adhesive layer 12 preferably has a thickness of 1000 μm or less.

The substrate 13 of the adhesive sheet X is a part that functions as a support in the adhesive sheet X and has transparency. Examples of the material for forming such a substrate 13 include polyester, such as polyethylene terephthalate (PET), polyolefin, such as polypropylene and polyethylene, polycarbonate, polyamide, polyimide, acrylic, polystyrene, acetate, polyether sulfone, tri Acetyl cellulose, and ITO (tin doped indium oxide). The substrate 13 may be made of one kind of material or two or more kinds of materials. The surface of the substrate 13 on the side of the adhesive layer 11 and the surface of the substrate 13 on the side of the adhesive layer 12 may each be subjected to a surface treatment for improving adhesion to the adhesive layer. Such surface treatment includes physical treatment, such as corona treatment and plasma treatment, and chemical treatment, such as undercoating treatment. Such a substrate 13 has a thickness of 15 to 150 μm, preferably 25 to 125 μm, and more preferably 38 to 100 μm.

The adhesive sheet X for optical use having the above-described configuration has a total light transmittance in the visible light wavelength region of, for example, 85% or more. The total light transmittance is a value measured according to JIS K 7361-1. The haze of the optical adhesive sheet X is, for example, 10% or less. The haze is a value measured according to JIS K 7136.

The adhesive sheet X may have a separator (release liner) for covering the adhesive surface 11a of the adhesive layer 11, and a separator (release liner) for covering the adhesive surface 12a of the adhesive surface 12. The separator is an element for protecting the adhesive layer 11 and/or 12 of the adhesive sheet X so as not to be exposed, and is peeled from the adhesive sheet X before the adhesive sheet X is bonded to the adherend. Examples of the separator include a substrate having a release treatment layer, a low adhesion substrate made of a fluoropolymer, and a low adhesion substrate made of a nonpolar polymer. The surface of the separator may be subjected to release treatment, antifouling treatment, or antistatic treatment. The separator has a thickness of, for example, 5 to 200 μm.

The adhesive sheet X having the above-described configuration can be produced by, for example, forming each of the adhesive layers 11, 12, and thereafter bonding each of the adhesive layers 11, 12 to the substrate 13. The adhesive layer 11 is formed by, for example, applying an adhesive composition for forming the adhesive layer 11 on a predetermined release liner to form an adhesive composition layer, laminating another release liner on the adhesive composition layer, and curing the adhesive composition between the release liners. Preferably, the adhesive composition for forming the adhesive layer 11 is an acrylic adhesive composition containing a photopolymerization initiator, and the curing means is an active energy ray irradiation including ultraviolet irradiation or the like. That is, it is preferable that the adhesive layer 11 is a cured product of an active energy ray irradiation-curable acrylic adhesive composition. On the other hand, the adhesive layer 12 may be formed by, for example, applying an adhesive composition for forming the adhesive layer 12 on a predetermined release liner to form an adhesive composition layer, laminating another release liner on the adhesive composition layer, and curing the adhesive composition between the release liners. Preferably, the adhesive composition for forming the adhesive layer 12 is an acrylic adhesive composition containing a photopolymerization initiator, and the curing means is an active energy ray irradiation including ultraviolet irradiation or the like. That is, it is preferable that the adhesive layer 12 is a cured product of an active energy ray irradiation-curable acrylic adhesive composition.

As described above, the adhesive layer 11 of the adhesive sheet X has a storage modulus at 95° C. of 1.0×10⁴ Pa or more, preferably 5.0×10⁴ Pa or more, and more preferably 1.0×10⁵ Pa or more. It is known that a transparent resin cover such as a polycarbonate cover for use in a liquid crystal display device often generates so-called outgas under a high-temperature environment or a high-humidity environment. Under such circumstances, the above-described configuration related to the storage modulus of the adhesive layer 11 is suitable for suppressing occurrence of defects such as partial detachment and peeling of the adhesive layer 11 or the adhesive sheet X due to outgas from the resin cover when the adhesive sheet X is bonded to the resin cover on the side of the adhesive layer 11. That is, the configuration is suitable for suppressing occurrence of defects due to outgas in the bonding state by ensuring the hardness of the adhesive layer 11 under high temperature conditions.

The adhesive layer 11 of the adhesive sheet X has a thickness of 30 μm or more, preferably 50 μm or more, and more preferably 80 μm or more as described above. As mentioned above, printing is often applied to the liquid crystal panel side surface of a transparent cover for liquid crystal display devices along the cover periphery. When the adhesive sheet X is bonded to the transparent cover on the side of the adhesive layer 11, the above-described configuration related to the thickness of the adhesive layer 11 is suitable for suppressing the occurrence of defects, such as partial detachment of the adhesive layer 11 or the adhesive sheet X, due to step difference on the transparent cover printed surface. That is, this configuration is suitable for securing step followability of the adhesive layer 11 and suppressing occurrence of defects due to steps of printed portion in the bonded state. In addition, the thickness of the adhesive layer 11 is preferably 500 μm or less as described above. Such a configuration is suitable for securing a high shear adhesive force of the adhesive layer 11 to the resin cover. As described above, the shear adhesive strength of the adhesive layer 11 to the polycarbonate is 10 N/cm² or more, preferably 15 N/cm² or more, and more preferably 20 N/cm² or more. Such a configuration is suitable for securing adhesion reliability of the adhesive layer 11 or the adhesive sheet X to the resin cover. In the case where a polycarbonate cover which easily generates outgas under a high-temperature environment or a high-humidity environment is adopted as a resin cover of a liquid crystal display device, such a configuration is suitable for securing adhesion reliability of the adhesive layer 11 or the adhesive sheet X to the polycarbonate cover.

Polarizing films for liquid crystal panels tend to exhibit the property of shrinking when the temperature rises from room temperature and of expanding when the temperature falls to room temperature, and the dimensional change is relatively large. As described above, the adhesive layer 12 of the adhesive sheet X has a loss tangent at 95° C. of 0.08 or more, preferably 0.1 or more, more preferably 0.12 or more, and even more preferably 0.15 or more. Such a configuration is suitable in that, when the adhesive sheet X is bonded to the polarizing film of the liquid crystal panel on the adhesive layer 12 side, the adhesive layer 12 or the adhesive sheet X follows the dimensional change in the surface spreading direction of the polarizing film according to temperature change to relax the stress at the bonding interface between the polarizing film and the adhesive layer 12. Such stress relaxation at the bonding interface between the polarizing film and the adhesive layer 12 is useful for securing the adhesion reliability of the adhesive layer 12 or the adhesive sheet X to the polarizing film. In addition, as described above, the adhesive layer 12 of the adhesive sheet X preferably has a thickness of 100 μm or more, more preferably 150 μm or more, more preferably 200 μm or more, and even more preferably 250 μm or more. Such a configuration is suitable for securing the ability of the adhesive layer 12 to follow the dimensional change of the polarizing film as the adherend, therefore, the configuration is suitable for relaxing the stress at the bonding interface between the adhesive layer 12 and the polarizing film. The adhesive layer 12 preferably has a thickness of 1000 μm or less as described above. Such a configuration is suitable for securing a high shear adhesion force of the adhesive layer 12 to the polarizing film.

The substrate 13 of the adhesive sheet X has a thickness of 15 to 150 μm, preferably 25 to 125 μm, and more preferably 38 to 100 μm as described above. The configuration in which the substrate 13 has a thickness of 15 μm or more is suitable for securing the function of the substrate 13 as a support in the adhesive sheet X, and thereby suppressing or preventing wrinkles from occurring in the adhesive sheet X at the time of handling such as bonding work of the adhesive sheet X. The configuration in which the substrate 13 has a thickness of 150 μm or less is suitable for suppressing defects, such as partial detachment of the optical adhesive sheet, due to step difference on the resin cover printed surface when the adhesive sheet X is bonded to the transparent cover for liquid crystal display devices on the adhesive layer 11 side. That is, the configuration is suitable for securing step followability of the adhesive layer 11 to suppress occurrence of defects due to steps of printed portion in the bonded state. When the substrate 13 has a thickness of more than 150 μm, the rigidity of the substrate 13 and the rigidity of the adhesive sheet X including the substrate 13 tend to be excessive. If the rigidity of the adhesive sheet X is excessive, excellent step followability of the adhesive sheet X may not be ensured in some cases.

The adhesive sheet X for optical use as described above is suitable for filling the space between the polarizing film and the resin cover in the liquid crystal display device.

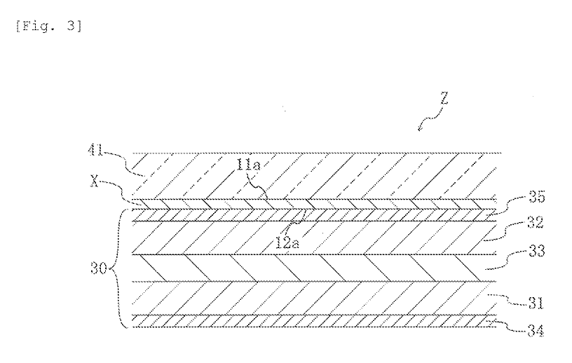

FIG. 2 is a partial cross-sectional view of a polarizing film Y with an adhesive layer according to one embodiment of the present invention. The adhesive layer-attached polarizing film Y has a lamination structure including the polarizing film 21 and the adhesive sheet X. The polarizing film 21 is a polarizing film for use in liquid crystal panels, and for example, includes a polarizer and at least one transparent protective film which is provided on one side or on each of both sides of the polarizer. The polarizing film 21 has a thickness of, for example, 30 to 300 μm. The adhesive sheet X has a lamination structure including adhesive layers 11, 12 and a substrate 13 therebetween as shown in FIG. 1, and is bonded to the polarizing film 21 on the side of the adhesive layer 12 (second adhesive layer). A separator (release liner) may be provided on the side of the adhesive sheet X opposite to the polarizing film 21 so as to cover the adhesive surface 11a of the adhesive layer 11. The adhesive layer-attached polarizing film Y provides a polarizing film for liquid crystal panels in which an optical adhesive sheet X has already been provided. The adhesive sheet X is suitable for filling the space between the polarizing film and the resin cover in the liquid crystal display device.

FIG. 3 is a partial multilayer configuration diagram of a liquid crystal display device Z according to one embodiment of the present invention. The liquid crystal display device Z has a multilayer structure portion including a liquid crystal panel 30, a resin cover 41, and an adhesive sheet X therebetween.

The liquid crystal panel 30 has a multilayer structure including a glass substrate 31 with transparent electrodes, a glass substrate 32 with a transparent electrode, a liquid crystal layer 33 positioned therebetween, and polarizing films 34, 35, and is configured to implement a so-called liquid crystal shutter function. The glass substrate 31 is accompanied by pixel electrodes as the transparent electrodes on the liquid crystal layer 33 side. The glass substrate 32 has a counter electrode as the transparent electrode on the liquid crystal layer 33 side. The polarizing film 34 is disposed on the side of the glass substrate 31 and is located at one end in the stacking direction of the liquid crystal panel 30. The polarizing film 35 is disposed on the side of the glass substrate 32 and is located at the end closest to the resin cover 41 in the stacking direction on the liquid crystal panel 30. Each of the polarizing films 34, 35 is a polarizing film for use in liquid crystal panels, and for example, includes a polarizer and at least one transparent protective film which is provided on one side or on each of both sides of the polarizer. Each of the polarizing films 34, 35 has a thickness of, for example, 30 to 300 μm.

The liquid crystal panel 30 preferably includes on-cell type touch sensors or in-cell type touch sensors. The on-cell type touch sensors (not shown) are a set of touch sensors arranged on, for example, the opposite side of the glass substrate 32 from the liquid crystal layer 33 to perform a touch panel function. The in-cell type touch sensors (not shown) are a set of touch sensors arranged on, for example, the liquid crystal layer 33 side of the glass substrate 31 to perform a touch panel function. A liquid crystal panel with on-cell type touch sensors or a liquid crystal panel with in-cell type touch sensors has a touch panel function incorporated in the liquid crystal panel 30. Such a liquid crystal panel is advantageous for reducing the thickness, weight, and manufacturing cost of the entire unit having both the touch panel function and the liquid crystal shutter function.

The resin cover 41 is a transparent cover for liquid crystal display devices and constitutes the foremost surface of the display screen of the liquid crystal display device Z. The resin cover 41 may be a transparent polycarbonate cover or a polymethyl methacrylate cover. A transparent cover made of resin is preferable to a transparent cover made of glass from the viewpoint of safety and light weight. In particular, in-vehicle liquid crystal display devices are strongly required to have such safety and lightness.

As shown in FIG. 1, the adhesive sheet X has a lamination structure including adhesive layers 11 and 12 and a base material 13 therebetween. The adhesive sheet X in the liquid crystal display device Z is bonded to the resin cover 41 on the side of the adhesive layer 11 (first adhesive layer), and bonded to the polarizing film 35 of the liquid crystal panel 30 on the side of the adhesive layer 12 (second adhesive layer). The lamination structure portion including the polarizing film 35 and the adhesive sheet X in the liquid crystal display device Z may be provided by polarizing film Y having the adhesive layer described above.

The liquid crystal display device Z with the above-described structure has an optical adhesive sheet X which fills the gap between the polarizing film 35 of the liquid crystal panel 30 and the resin cover 41. Therefore, the liquid crystal display device Z can provide the technical advantage mentioned above concerning the adhesive sheet X.

### EXAMPLES

Hereinafter, the present invention will be described in more detail based on examples, but the present invention is not limited to these examples.

### Production Example of Oligomer

A mixture including 60 parts by weight of dicyclopentanyl methacrylate (DCPMA), 40 parts by weight of methyl methacrylate (MMA), 3.5 parts by weight of α thioglycerol as a chain transfer agent, and 100 parts by weight of toluene as a polymerization solvent was stirred in a reaction vessel at 70° C. for 1 hour under a nitrogen atmosphere. Then, 0.2 parts by weight of 2,2′-azobisisobutyronitrile as a polymerization initiator was added to the mixture in the reaction vessel to prepare a reaction solution, and the reaction was performed at 70° C. for 2 hours. Subsequently, the reaction was performed at 80° C. for 2 hours. Thereafter, the reaction solution in the reaction vessel was placed in a temperature atmosphere of 130° C., and toluene, the chain transfer agent, and the unreacted monomers were removed by drying from the reaction solution to obtain a solid acrylic oligomer Ao. The acrylic oligomer Ao had a weight average molecular weight (Mw) of 5. 1×10³.

### Preparation Example of Acrylic Adhesive Composition C1

A monomer mixture (100 parts by weight) including 78 parts by weight of 2-ethylhexyl acrylate (2EHA), 18 parts by weight of N-vinyl-2-pyrrolidone (NVP), and 4 parts by weight of hydroxyethyl acrylate (HEA) was prepared. The monomer mixture, 0.035 parts by weight of a first photopolymerization initiator (trade name “Irgacure 651,” manufactured by BASF Co.), and 0.035 parts by weight of a second photopolymerization initiator (trade name “IRGACURE 184,” manufactured by BASF) were mixed. The mixture was irradiated with ultraviolet light using an ultraviolet irradiation device while measuring the viscosity of the mixture using a viscosity measuring apparatus. In viscosity measurement, the rotor rotation speed of the apparatus was 10 rpm, and the measurement temperature was 30° C. The ultraviolet irradiation was continued until the viscosity of this mixture reached about 20 Pa·s to give a prepolymer composition. The prepolymer composition contained a partially polymerized product produced by polymerization of a part of monomer components in the mixture, and monomer components remaining without being consumed in the polymerization reaction. Then, 100 parts by weight of the prepolymer composition, 11.8 parts by weight of the acrylic oligomer Ao, 17.6 parts by weight of hydroxyethyl acrylate (HEA), 0.294 parts by weight of 1,6-hexanediol diacrylate (HDDA), and 0.353 parts by weight of a silane coupling agent (trade name “KBM-403” manufactured by Shin-Etsu Chemical Co., Ltd.) were mixed to obtain an acrylic adhesive composition C1.

### Preparation Example of Acrylic Adhesive Composition C2

An acrylic adhesive composition C2 was obtained in the same procedure as the acrylic adhesive composition C1 except for using 0.088 parts by weight of the amount of 1,6-hexanediol diacrylate (HDDA) instead of 0.294 parts by weight.

### Preparation Example of Acrylic Adhesive Composition C3

A monomer mixture (100 parts by weight) including 67 parts by weight of butyl acrylate (BA), 14 parts by weight of cyclohexyl acrylate (CHA), and 19 parts by weight of hydroxybutyl acrylate (HBA) was prepared. The monomer mixture, 0.09 parts by weight of a first photopolymerization initiator (trade name “Irgacure 651,” manufactured by BASF) and 0.09 part by weight of a second photopolymerization initiator (trade name “Irgacure 184,” manufactured by BASF) were mixed. The mixture was irradiated with ultraviolet light using an ultraviolet irradiation device while measuring the viscosity of the mixture using a viscosity measuring apparatus. In viscosity measurement, the rotor rotation speed of the apparatus was 10 rpm, and the measurement temperature was 30° C. The ultraviolet irradiation was continued until the viscosity of this mixture reached about 20 Pa·s to give a prepolymer composition. The prepolymer composition contained a partially polymerized product produced by polymerization of a part of monomer components in the mixture, and monomer components remaining without being consumed in the polymerization reaction. Then, 100 parts by weight of the prepolymer composition, 9 parts by weight of hydroxyethyl acrylate (HEA), 8 parts by weight of hydroxybutyl acrylate (HBA), 0.12 parts by weight of dipentaerythritol hexaacrylate (DPHA), and 0.3 parts by weight of a silane coupling agent (trade name “KBM-403,” manufactured by Shin-Etsu Chemical Co., Ltd.) were mixed to obtain an acrylic adhesive composition C3.

### Preparation Example of Acrylic Adhesive Composition C4

A monomer mixture (100 parts by weight) including 40.5 parts by weight of 2-ethylhexyl acrylate (2EHA), 40.5 parts by weight of isostearyl acrylate (ISTA), 18 parts by weight of N-vinyl-2-pyrrolidone (NVP), and 1 parts by weight of hydroxybutyl acrylate (HBA) was prepared. The monomer mixture, 0.05 part by weight of a first photopolymerization initiator (trade name “IRGACURE 651,” manufactured by BASF) and 0.05 part by weight of a second photopolymerization initiator (trade name “IRGACURE 184,” manufactured by BASF) were mixed. The mixture was irradiated with ultraviolet light using an ultraviolet irradiation device while measuring the viscosity of the mixture using a viscosity measuring apparatus. In viscosity measurement, the rotor rotation speed of the apparatus was 10 rpm, and the measurement temperature was 30° C. The ultraviolet irradiation was continued until the viscosity of this mixture reached about 20 Pa·s to give a prepolymer composition. The prepolymer composition contained a partially polymerized product produced by polymerization of a part of the monomer components in the mixture, and monomer components remaining without being consumed in the polymerization reaction. Then, 100 parts by weight of the prepolymer composition, 0.15 parts by weight of trimethylolpropane triacrylate, 0.15 parts by weight of α thioglycerol as a chain transfer agent, and 1 part by weight of triphenyl phosphite (Trade name “Chelex P,” manufactured by Sakai Chemical Industry Co., Ltd.), and 0.3 parts by weight of a silane coupling agent (trade name “KBM-403,” manufactured by Shin-Etsu Chemical Co., Ltd.) were mixed to obtain an acrylic adhesive composition C4.

### Example 1

### Formation of First Adhesive Layer

The acrylic adhesive composition C1 was applied on a polyethylene terephthalate (PET)-based release liner (thickness 125 μm, manufactured by Nitto Denko Corporation) to form an adhesive composition layer. Then, another PET release liner (thickness 125 μm, manufactured by Nitto Denko Corporation) was laminated on the adhesive composition layer to coat the adhesive composition layer and to block oxygen. The laminate (laminate L1′) thus obtained had a lamination structure of [release liner/adhesive composition layer/release liner]. Then, ultraviolet light having an illuminance of 3 mW/cm² was irradiated to the laminate L1 from the side of one release liner for 300 seconds using Black Light (manufactured by Toshiba Lighting & Technology Corporation). This irradiation caused the adhesive composition layer in the laminate L1′ to be cured to form an adhesive layer (first adhesive layer), and a laminate (laminate L1) having a lamination structure of [release liner/adhesive layer (first adhesive layer)/release liner] was obtained. The first adhesive layer in the laminate L1 had a thickness of 100 μm.

### Formation of Second Adhesive Layer

The acrylic adhesive composition C2 was applied on a polyethylene terephthalate (PET)-based release liner (thickness 125 μm, manufactured by Nitto Denko Corporation) to form an adhesive composition layer. Then, a PET release liner (thickness 125 μm, manufactured by Nitto Denko Corporation) was further lamination on the adhesive composition layer to coat the adhesive composition layer and to block oxygen. The laminate (laminate L2′) thus obtained had a lamination structure of [release liner/adhesive composition layer/release liner]. Then, ultraviolet light having an illuminance of 3 mW/cm² was irradiated to the laminate L2 from the side of one release liner for 300 seconds using Black Light (manufactured by Toshiba Lighting & Technology Corporation). This irradiation caused the adhesive composition layer of in laminate L2′ to be cured to form an adhesive layer (second adhesive layer), and a laminate (laminate L2) having a lamination structure of [release liner/adhesive layer (second adhesive layer)/release liner] was obtained. The second adhesive layer in the laminate L2 had a thickness of 500 μm.

### Preparation of Optical Adhesive Sheet

A PET film F₁, obtained by subjecting a polyethylene terephthalate film (trade name “Lumirror S10,” manufactured by Toray Industries, Inc.) having a thickness of 50 μm on its both sides to corona treatment, was prepared. One of the release liners was peeled off from the laminate L1 (release liner/first adhesive layer/release liner). The single liner-attached first adhesive layer was bonded to one side of the PET film F1 via the surface of the first adhesive layer once exposed by this peeling. Thereby, a laminate having a lamination structure of [release liner/first adhesive layer/PET Film F1] was obtained. Then, one of the release liners was peeled off from the laminate L2 (release liner/second adhesive layer/release liner), and the single liner-attached second adhesive layer was bonded to the other side of the PET film F1 via the surface of the second adhesive layer once exposed by this peeling. Thereby, an optical adhesive sheet having a lamination structure of [release liner/first adhesive layer (thickness of 100 μm)/PET film F1 (thickness of 50 μm)/second adhesive layer (thickness of 500 μm)/release liner] was obtained. The optical adhesive sheet of Example 1 had a thickness of 650 μm excluding thicknesses of the release liners.

### Example 2

An optical adhesive sheet of Example 2 was produced in the same manner as in Example 1 except that a PET film F₂, obtained by subjecting a polyethylene terephthalate film (trade name “Cosmoshine super birefringent type,” manufactured by Toyobo Co., Ltd.) having a thickness of 80 μm to corona treatment on its both sides, was used as the substrate of the optical adhesive sheet instead of the PET film F1. The optical adhesive sheet of Example 2 had a thickness of 680 μm excluding thicknesses of the release liners.

### Example 3

An optical adhesive sheet of Example 3 was produced in the same manner as in Example 1 except that a PET film F2 having a thickness of 80 μm was used instead of the PET film F1 having a thickness of 50 μm as a substrate for an optical adhesive sheet, an acrylic adhesive composition C3 was used as a material for forming the second adhesive layer instead of the acrylic adhesive composition C1, and the thickness of the second adhesive layer was set to 250 μm instead of 500 μm. The optical adhesive sheet of Example 3 had a thickness of 430 μm excluding thicknesses of the release liners.

### Example 4

An optical adhesive sheet of Example 4 was produced in the same manner as in Example 1 except that a polycarbonate (PC) film (trade name “Pure ACE C110,” manufactured by Teijin Ltd.) having a thickness of 100 μm was used as a substrate of the optical adhesive sheet instead of the PET film F1 having a thickness of 50 μm. The optical adhesive sheet of Example 4 had a thickness of 700 μm excluding thicknesses of the release liners.

### Example 5

An optical adhesive sheet of Example 5 was produced in the same manner as in Example 1 except that a PC film (trade name “Pure ACE C110,” manufactured by Teijin Ltd.) having a thickness of 100 μm was used as a substrate of the optical adhesive sheet instead of the PET film F1 having a thickness of 50 μm, and an acrylic adhesive composition C3 was used as a material for forming the second adhesive layer instead of the acrylic adhesive composition C1, and the thickness of the second adhesive layer was set to 250 μm instead of 500 μm. The optical adhesive sheet of Example 5 had a thickness of 450 μm excluding thicknesses of the release liners.

### Example 6

An optical adhesive sheet of Example 6 was produced in the same manner as in Example 1 except that a transparent conductive film (PET/ITO film, trade name “Elecresta,” manufactured by Nitto Denko Corporation) including a lamination structure of a PET film and an ITO layer and having a thickness of 50 μm was used instead of the PET film F1. The optical adhesive sheet of Example 6 had a thickness of 650 μm excluding thicknesses of the release liners.

### Example 7

An optical adhesive sheet of Example 7 was produced in the same manner as in Example 1 except that a PET/ITO film (trade name “Elecresta,” manufactured by Nitto Denko Corporation) having a thickness of 50 μm was used as a substrate of the optical adhesive sheet instead of the PET film F1, acrylic adhesive composition C2 was used as a material for forming the second adhesive layer instead of acrylic adhesive composition C1, and the thickness of the second adhesive layer was set to 250 μm instead of 500 μm. The optical adhesive sheet of Example 7 had a thickness of 400 μm excluding thicknesses of the release liners.

### Example 8

An optical adhesive sheet of Example 8 was produced in the same manner as in Example 1 except that a PET/ITO film (trade name “Elecresta,” manufactured by Nitto Denko Corporation) having a thickness of 50 μm was used as a substrate of the optical adhesive sheet instead of the PET film F1, acrylic adhesive composition C2 was used as a material for forming the second adhesive layer instead of acrylic adhesive composition C1, and the thickness of the second adhesive layer was set to 100 μm instead of 500 μm. The optical adhesive sheet of Example 8 had a thickness of 250 μm excluding thicknesses of the release liners.

### Example 9

An optical adhesive sheet of Example 9 was produced in the same manner as in Example 1 except that acrylic adhesive composition C3 was used as a material for forming the second adhesive layer instead of acrylic adhesive composition C1, and the thickness of the second adhesive layer was set to 250 μm instead of 500 μm. The optical adhesive sheet of Example 9 had a thickness of 400 μm excluding thicknesses of the release liners.

### Example 10

An optical adhesive sheet of Example 10 was produced in the same manner as in Example 1 except that acrylic adhesive composition C3 was used as a material for forming the first adhesive layer instead of acrylic adhesive composition C1, PET film F2 having a thickness of 80 μm was used as a substrate of the optical adhesive sheet instead of the PET film F1 having a thickness of 50 μm. The optical adhesive sheet of Example 10 had a thickness of 680 μm excluding thicknesses of the release liners.

### Example 11

An optical adhesive sheet of Example 11 was produced in the same manner as in Example 1 except that acrylic adhesive composition C2 was used as a material for forming the first adhesive layer instead of acrylic adhesive composition C1, the thickness of the first adhesive layer was set to 175 μm instead of 100 μm, PET film F2 having a thickness of 80 μm was used as a substrate of the optical adhesive sheet instead of the PET film F1 having a thickness of 50 μm, acrylic adhesive composition C4 was used as a material for forming the second adhesive layer instead of acrylic adhesive composition C1, and the thickness of the second adhesive layer was set to 250 μm instead of 500 μm. The optical adhesive sheet of Example 11 had a thickness of 505 μm excluding thicknesses of the release liners.

### Comparative Example 1

An optical adhesive sheet of Comparative Example 1 was produced in the same manner as in Example 1 except that the thickness of the first adhesive layer was set to 25 μm instead of 100 μm. The optical adhesive sheet of Comparative Example 1 had a thickness of 575 μm excluding thicknesses of the release liners.

### Comparative Example 2

An optical adhesive sheet of Comparative Example 2 was produced in the same manner as in Example 1 except that a PET film F₃, obtained by subjecting a polyethylene terephthalate film (trade name “Lumirror S10,” manufactured by Toray Industries, Inc.) having a thickness of 175 μm to corona treatment on its both sides, was used as the substrate of the optical adhesive sheet instead of the PET film F₁. The optical adhesive sheet of Comparative Example 2 had a thickness of 775 μm excluding thicknesses of the release liners.

### Comparative Example 3

An optical adhesive sheet of Comparative Example 3 was produced in the same manner as in Example 1 except that a PET film F₄, obtained by subjecting a polyethylene terephthalate film (trade name “Lumirror S10,” manufactured by Toray Industries, Inc.) having a thickness of 12 μm to corona treatment on its both sides was used as the substrate of the optical adhesive sheet instead of the PET film F₁. The optical adhesive sheet of Comparative Example 3 had a thickness of 612 μm excluding thicknesses of the release liners. Since the PET film F₄ as the substrate was thin, wrinkles easily occurred in the adhesive sheet during the process of manufacturing the optical adhesive sheet of Comparative Example 3.

### Comparative Example 4

An optical adhesive sheet of Comparative Example 4 was produced in the same manner as in Example 1 except that the thickness of the second adhesive layer was set to 50 μm instead of 500 μm. The optical adhesive sheet of Comparative Example 4 had a thickness of 200 μm excluding thicknesses of the release liners.

### Comparative Example 5

An optical adhesive sheet of Comparative Example 5 was produced in the same manner as in Example 1 except that acrylic adhesive composition C4 was used as a material for forming the first adhesive layer instead of acrylic adhesive composition C1. The optical adhesive sheet of Comparative Example 5 had a thickness of 650 μm excluding thicknesses of the release liners.

### Comparative Example 6

The acrylic adhesive composition C1 was applied on a PET-based release liner (thickness 125 μm, manufactured by Nitto Denko Corporation) to form an adhesive composition layer. Then, another PET release liner (thickness 125 μm, manufactured by Nitto Denko Corporation) was laminated on the adhesive composition layer to coat the adhesive composition layer and to block oxygen. The laminate thus obtained had a lamination structure of [release liner/adhesive composition layer/release liner]. Then, ultraviolet light having an illuminance of 3 mW/cm² was irradiated to the laminate from the side of one release liner for 300 seconds using Black Light (manufactured by Toshiba Lighting & Technology Corporation). This caused the adhesive composition layer of the laminate to be cured to form an adhesive layer, and a laminate having a lamination structure of [release liner/adhesive layer/release liner] was obtained. The adhesive layer in the laminate had a thickness of 500 μm. As described above, the optical adhesive sheet of Comparative Example 6 having a single acrylic adhesive layer having a thickness of 500 μm was prepared.

### Comparative Example 7

Another laminate L1 having the same structure (release liner/first adhesive layer (thickness 100 μm)/release liner) as the laminate L1 described in Example 1 was prepared. On the other hand, the acrylic adhesive composition C3 was applied on a PET release liner (thickness 125 μm, manufactured by Nitto Denko Corporation) to form an adhesive composition layer. Then, another PET release liner (thickness 125 μm, manufactured by Nitto Denko Corporation) was laminated on the adhesive composition layer to coat the adhesive composition layer and to block oxygen. The laminate (laminate L3′) thus obtained had a lamination structure of [release liner/adhesive composition layer/release liner]. Then, ultraviolet light having an illuminance of 3 mW/cm² was irradiated to the laminate L3′ from the side of one release liner for 300 seconds using Black Light (manufactured by Toshiba Lighting & Technology Corporation). This irradiation caused the adhesive composition layer of the laminate L3′ to be cured to form an adhesive layer, and a laminate (laminate L3) having a lamination structure of [release liner/adhesive layer (second adhesive layer)/release liner] was obtained. The second adhesive layer in the laminate L3 had a thickness of 250 μm. Then, one of the release liners was peeled off from the laminate L1 [release liner/first adhesive layer (thickness 100 μm)/release liner] and one of the release liners was peeled off from laminate L3 [release liner/second adhesive layer (thickness 250 μm)/release liner]. The single liner-attached first adhesive layer and the single liner-attached second adhesive layer were bonded via their surfaces once exposed by these peelings. As described above, the optical adhesive sheet of Comparative Example 7 having a lamination structure of [release Liner/first adhesive layer (thickness 100 μm)/second adhesive layer (thickness 250 μm)/release liner] was prepared. The optical adhesive sheet of Comparative Example 7 had a thickness of 350 μm excluding thicknesses of the release liners.

### Storage Modulus of First Adhesive Layer and Loss Tangent of Second Adhesive Layer

The storage modulus of the first adhesive layer and the loss tangent of the second adhesive layer in each of the optical adhesive sheets of Examples 1 to 11 and Comparative Examples 1 to 5 were determined by dynamic viscoelasticity measurement. Measurement samples to be subjected to the dynamic viscoelasticity measurement for determining the storage modulus of the first adhesive layer were prepared respectively for each optical adhesive sheet as follows. First, the required number of the laminates (Laminate L1) each of which has a lamination structure of [release liner/adhesive layer (first adhesive layer having thickness of 100 μm)/release liner] were prepared in the same manner as Laminate L1 in Example 1 by using the acrylic adhesive composition (a constitution material of the first adhesive layer of the optical adhesive sheet) as an adhesive layer forming material. Then the release liner was peeled off from each prepared laminate L1, and the adhesive layers were sequentially bonded to each other to prepare a laminated adhesive layer sheet having a thickness of about 2 mm. Subsequently, the laminated adhesive layer sheet was punched out to obtain columnar pellet (diameter: 7.9 mm), which was adopted as a measurement sample. Measurement samples to be subjected to the dynamic viscoelasticity measurement for determining the loss tangent of the second adhesive layer were prepared respectively for each optical adhesive sheet as follows. First, the required number of the laminates (Laminate L2) each of which has a lamination structure of [release liner/adhesive layer (second adhesive layer having thickness of 500 μm)/release liner] were prepared in the same manner as Laminate L2 in Example 1 by using the acrylic adhesive composition (a constitution material of the second adhesive layer of the optical adhesive sheet) as an adhesive layer forming material. Then the release liner was peeled off from each prepared laminate L2, and the adhesive layers were sequentially bonded to each other to prepare a laminated adhesive layer sheet having a thickness of about 2 mm. Subsequently, the laminated adhesive layer sheet was punched out to obtain columnar pellets (diameter: 7.9 mm), which was adopted as measurement sample. For each prepared measurement sample, a dynamic viscoelasticity measurements was performed after fixing the measurement sample on a jig of 7.9 mm diameter parallel plate by using a dynamic viscoelasticity measuring device (trade name “ARES,” manufactured by Rheometrics Co., Ltd.). The measurement conditions were set as follows: the measurement mode: shear mode; the measurement temperature range: −70° C. to 150° C.; the heating rate: 5° C./min; and the frequency: 1 Hz. As such, the temperature dependencies of the storage modulus G′, loss elastic modulus G″ and loss tangent tan δ (=loss elastic modulus G″/storage modulus G′) of each of the measurement samples were measured. The storage modulus G′ at 95° C. of the first adhesive layer and the loss tangent tan 5 at 95° C. of the second adhesive layer of each of the optical adhesive sheets of Examples 1 to 11 and Comparative Examples 1 to 5 are shown in Tables 1 and 2.

### Shear Adhesive Force

The shear adhesion force to polycarbonate of the first adhesive layer in each of the optical adhesive sheets of Examples 1 to 11 and Comparative Examples 1 to 5 and 7, and the shear adhesion force to polycarbonate of the optical adhesive sheet of Comparative Example 6 (comprising a single adhesive layer) were measured by a tensile shear test. The measurement samples to be subjected to the tensile shear test were prepared respectively as follows. First, the optical adhesive sheet of Comparative Example 6, comprising a single adhesive layer, or a laminate (release liner/adhesive layer (first adhesive layer)/release liner) including the first adhesive layer in one of the optical adhesive sheets of Examples 1 to 11 and Comparative Examples 1 to 5 and 7 was prepared in the same manner as described for Laminate L1 in Example 1. Then an adhesive piece (10 mm×10 mm) was cut out from the adhesive layer. Then one side of the adhesive piece was bonded to an acrylic plate (50 mm×100 mm) and the other side of the adhesive piece was bonded to the polycarbonate surface of a composite sheet (trade name “Iupilon Sheet HMRS 51 T,” manufactured by Mitsubishi Gas Chemical Company, Ltd., 90 mm×160 mm) having two-layer structure of a polycarbonate layer and a polymethylmethacrylate layer. The structure thus obtained was adopted as a measurement sample. For each prepared measurement sample, after being left to stand under the environment of 95° C. for 30 minutes, the acrylic plate and the composite sheet bonded to each other via the adhesive piece therebetween were pulled in opposite directions at a pulling speed of 2 mm/min under the environment of 95° C. while measuring the tensile force. The maximum value measured in such the tensile shear test was defined as shear adhesion (N/cm²). The results are shown in Tables 1 and 2.

### Step Followability

The step followability of each of the optical adhesive sheets of Examples and Comparative Examples was examined using so-called printed glass. The printed glass had a patterned printed layer forming a printed step of 45 μm on the glass surface. On the surface with printed pattern of such a printed glass, an optical adhesive sheet was bonded on the side of the first adhesive layer at room temperature by using a hand roller. An adhesive sheet, bonded to the printed glass, not having detachment with a width of 1 mm or more along the edge of the printed pattern (the step of printed portion) on the glass surface was judged to be the adhesive sheet having good (o) step followability. An adhesive sheet, bonded to the printed glass, having a detachment width of 1 mm or more along the edge of the printed pattern (the step of printed portion) was judged to be the adhesive sheet having poor (x) step followability. The results are shown in Tables 1 and 2.

### 95° C. Adhesion Reliability

Adhesion reliability of each of the optical adhesive sheets of Examples and Comparative Examples to polarizing film was examined by adhesion reliability test. Sample structures to be subjected to the adhesion reliability test were prepared respectively as follows. First, a polarizing film (trade name “SEG 1425 DU,” manufactured by Nitto Denko Corporation) was bonded to a glass plate (120 mm×180 mm) using a hand roller to prepare glass with a polarizing film. Then, one of the release liners (when the optical adhesive sheet has the first adhesive layer, the release liner on the side of the first adhesive layer) was peeled off from the optical adhesive sheet. The optical adhesive sheet was bonded to the polycarbonate surface of a composite sheet (trade name “Iupilon Sheet HMRS 51 T,” manufactured by Mitsubishi Gas Chemical Company, Ltd., 90 mm×160 mm) having two-layer structure of a polycarbonate layer and a polymethylmethacrylate layer, on the first adhesive layer side of the adhesive sheet. Then, the other release liner was peeled from the optical adhesive sheet bonded on the polycarbonate, and the optical adhesive sheet with the composite sheet was bonded to the surface of the polarizing film of the polarizing film-attached glass, prepared in advance, on the second adhesive layer side. When the optical adhesive sheet has a substrate as a constituent element, the polarizing film-attached glass and the optical adhesive sheet with the composite sheet were bonded in an orientation in which the flow direction (MD direction) of the substrate and the direction of the easy axis of transmission of the polarizing film were at an angle of 45 degrees. Thereafter, the polarizing film-attached glass and the optical adhesive sheet with the composite sheet were pressure-bonded by vacuum pressing. The vacuum pressing was performed under the conditions of the pressure of 0.3 MPa, the vacuum degree of 100 Pa, and the pressing time of 5 seconds. As such, the sample structures to be subjected to the adhesion reliability test at 95° C. was prepared respectively for each optical adhesive sheet. Then the sample structure prepared as described above was charged into an autoclave and autoclaved for 15 minutes at a temperature of 50° C. and a pressure of 0.5 MPa. The sample structure after the autoclave treatment was left to stand under an environment of 95° C. for 24 hours and then visually observed. Transmission observation of each sample structure in its thickness direction was possible. As a result of observation, the sample structure with no foaming and no peeling was evaluated as a sample structure having good (o) adhesion reliability at 95° C., and the sample structure with foaming or peeling was evaluated as poor (x) adhesion reliability at 95° C. The results are shown in Tables 1 and 2.

### Evaluation

The optical adhesive sheets of Examples 1 to 11, which have the constitution of the present invention, exhibited excellent step followability and also exhibited good adhesion reliability at 95° C. On the other hand, the optical adhesive sheets of Comparative Examples 1 to 7 did not exhibit satisfactory step followability and/or good adhesion reliability at 95° C. A specific explanation will be given below.

The optical adhesive sheet of Comparative Example 1 had a first adhesive layer of 25 μm. That was too thin to give good step followability. The optical adhesive sheet of Comparative Example 1, whose first adhesive layer had a too small thickness of 25 μm, was susceptible to influence of minute foreign materials in the space between the adhesive surface of the first adhesive layer and the adherend thereto, and failed to show good adhesion reliability at 95° C. The optical adhesive sheet of Comparative Example 2 failed to show good step followability since its substrate had a too large thickness of 175 μm and had excessive rigidity. In addition, the optical adhesive sheet of Comparative Example 2, which could provide no good step followability, was susceptible to influence of minute foreign materials in the space between the adhesive surface of the first adhesive layer and the adherend thereto, and failed to show good adhesion reliability at 95° C. The optical adhesive sheet of Comparative Example 3 had a too small thickness of the substrate of 12 μm and thus the substrate had too small rigidity. Therefore, wrinkles easily occurred in the optical adhesive sheet during the bonding operation to the substrate. Such an optical adhesive sheet of Comparative Example 3 tended to generate air bubbles between the substrate and the adhesive sheet due to the wrinkles, especially under the high temperature conditions, and failed to show good adhesion reliability at 95° C. The optical adhesive sheet of Comparative Example 4 failed to show good adhesion reliability at 95° C. since its second adhesive layer had a too small thickness of the of 50 μm and thus could not follow the dimensional change of the polarizing film in the above adhesion reliability test. The possible reason why the optical adhesive sheet of Comparative Example 4 failed to show good step followability was that 50 μm thickness of the second adhesive layer was too small, and the total thickness of the adhesive sheet was insufficient to absorb the step difference. The optical adhesive sheet of Comparative Example 5 failed to show good adhesion reliability at 95° C. since its first adhesive layer had a too small storage modulus at 95° C. and thus could not withstand the pressure of outgas from the polycarbonate layer of the composite sheet in the adhesion reliability test described above, then, allowing foams to generate between the first adhesive layer and the polycarbonate layer. The optical adhesive sheet of Comparative Example 6 of single adhesive layer failed to show good adhesion reliability at 95° C. A resin cover such as a polycarbonate cover tends to exhibit the property of expanding when the temperature rises from room temperature and of shrinking when the temperature falls to room temperature. This deformation characteristic is opposite to the characteristic of the polarizing film. The possible reason why the optical adhesive sheet of Comparative Example 6 of a single adhesive layer failed to show good adhesion reliability at 95° C. is that the single adhesive layer could not follow each dimensional change of the polycarbonate layer and the polarizing film, which tended to deform in opposite directions in the adhesion reliability test described above. The optical adhesive sheet of Comparative Example 7 failed to show good adhesion reliability at 95° C. since peeling was occurred at the interface between the first and second adhesive layers, which were directly bonded without interposing substrate, in the above adhesion reliability test.

TABLE 1

| | Example 1 | Example 2 | Example 3 | Example 4 | Example 5 | Example 6 | Example 7 | Example 8 | Example 9 |
|---|---|---|---|---|---|---|---|---|---|
| Acrylic adhesive composition | C1 | C1 | C1 | C1 | C1 | C1 | C1 | C1 | C1 |
| for the first adhesive layer | | | | | | | | | |
| Thickness of the first | 100 | 100 | 100 | 100 | 100 | 100 | 100 | 100 | 100 |
| adhesive layer (μm) | | | | | | | | | |
| Substrate | PETfilmF₁ | PETfilmF₂ | PETfilmF₂ | PC film | PC film | PET/ITO | PET/ITO | PET/ITO | PETfilmF₁ |
| | | | | | | film | film | film | |
| Thickness of substrate (μm) | 50 | 80 | 80 | 100 | 100 | 50 | 50 | 50 | 50 |
| Acrylic adhesive composition | C1 | C1 | C3 | C1 | C3 | C1 | C2 | C2 | C3 |
| for the second adhesive layer | | | | | | | | | |
| Thickness of the second | 500 | 500 | 250 | 500 | 250 | 500 | 250 | 100 | 250 |
| adhesive layer (μm) | | | | | | | | | |
| Storage modulus of the first | 1.1 × 10⁵ | 1.1 × 10⁵ | 1.1 × 10⁵ | 1.1 × 10⁵ | 1.1 × 10⁵ | 1.1 × 10⁵ | 1.1 × 10⁵ | 1.1 × 10⁵ | 1.1 × 10⁵ |
| adhesive layer G′ (Pa) | | | | | | | | | |
| Loss tangent tan δ of second | 0.1 | 0.1 | 0.16 | 0.1 | 0.16 | 0.1 | 0.19 | 0.19 | 0.16 |
| adhesive layer | | | | | | | | | |
| Shear adhesive strength | 34 | 34 | 34 | 34 | 34 | 34 | 34 | 34 | 34 |
| (N/cm²) | | | | | | | | | |
| Step followability | ∘ | ∘ | ∘ | ∘ | ∘ | ∘ | ∘ | ∘ | ∘ |
| Adhesion reliability at 95° C. | ∘ | ∘ | ∘ | ∘ | ∘ | ∘ | ∘ | ∘ | ∘ |

TABLE 2

| | Example | Example | Comparative | Comparative | Comparative | Comparative | Comparative | Comparative | Comparative |
|---|---|---|---|---|---|---|---|---|---|
| | 10 | 11 | Example 1 | Example 2 | Example 3 | Example 4 | Example 5 | Example 6 | Example 7 |
| Acrylic adhesive | C3 | C2 | C1 | C1 | C1 | C1 | C4 | C1 | C1 |
| composition for the | | | | | | | | | |
| first adhesive layer | | | | | | | | | |
| Thickness of the first | 100 | 175 | 25 | 100 | 100 | 100 | 100 | 500 | 100 |
| adhesive layer (μm) | | | | | | | | | |
| Substrate | PETfilmF₂ | PETfilmF₂ | PETfilmF₁ | PETfilmF₃ | PETfilmF₄ | PETfilmF₁ | PETfilmF₁ | — | — |
| Thickness of substrate | 80 | 80 | 50 | 175 | 12 | 50 | 50 | — | — |
| (μm) | | | | | | | | | |
| Acrylic adhesive | C1 | C4 | C1 | C1 | C1 | C1 | C1 | — | C3 |
| composition for the | | | | | | | | | |
| second adhesive layer | | | | | | | | | |
| Thickness of the second | 500 | 250 | 500 | 500 | 500 | 50 | 500 | — | 250 |
| adhesive layer (μm) | | | | | | | | | |
| Storage modulus of the | 9.5 × 10⁴ | 7.5 × 10⁴ | 1.1 × 10⁵ | 1.1 × 10⁵ | 1.1 × 10⁵ | 1.1 × 10⁵ | 7.7 × 10³ | — | — |
| first adhesive layer | | | | | | | | | |
| G′ (Pa) | | | | | | | | | |
| Loss tangent tan δ of | 0.1 | 0.73 | 0.1 | 0.1 | 0.1 | 0.07 | 0.1 | — | — |
| second adhesive layer | | | | | | | | | |
| Shear adhesive strength | 33 | 26 | 40 | 34 | 34 | 34 | 3 | 12 | 34 |
| (N/cm²) | | | | | | | | | |
| Step followability | ∘ | ∘ | x | x | ∘ | x | ∘ | ∘ | ∘ |
| Adhesion reliability at | ∘ | ∘ | x | x | x | x | x | x | x |
| 95° C. | | | | | | | | | |

### REFERENCE SIGNS LIST

X adhesive sheet (optical adhesive sheet)
Y polarizing film with adhesive layer
Z liquid crystal display device
11 adhesive layer (first adhesive layer)
12 adhesive layer (second adhesive layer)
13 substrate
21 polarizing film
30 liquid crystal panel
31, 32 glass plate
34, 35 polarizing film
41 resin cover (resin-made covering member)

1. An optical adhesive sheet comprising
a lamination structure including:
a first adhesive layer having a thickness of 30 μm or more and a storage modulus of 1.0×10⁴ Pa or more at 95° C.;
a second adhesive layer having a loss tangent of 0.08 or more at 95° C.; and
a substrate having a thickness of 15 to 150 μm and located between the first adhesive layer and the second adhesive layer.

2. The optical adhesive sheet according to claim 1, wherein the first adhesive layer has a shear adhesive strength to polycarbonate of 10 N/cm² or more.

3. The optical adhesive sheet according to claim 1, wherein the first adhesive layer has a thickness of 500 μm or less.

4. The optical adhesive sheet according to claim 2, wherein the first adhesive layer has a thickness of 500 μm or less.

5. The optical adhesive sheet according to claim 1, wherein the second adhesive layer has a thickness of 100 μm or more.

6. The optical adhesive sheet according to claim 2, wherein the second adhesive layer has a thickness of 100 μm or more.

7. The optical adhesive sheet according to claim 3, wherein the second adhesive layer has a thickness of 100 μm or more.

8. The optical adhesive sheet according to claim 1, wherein the second adhesive layer has a thickness of 1000 μm or less.

9. The optical adhesive sheet according to claim 2, wherein the second adhesive layer has a thickness of 1000 μm or less.

10. The optical adhesive sheet according to claim 3, wherein the second adhesive layer has a thickness of 1000 μm or less.

11. The optical adhesive sheet according to claim 5, wherein the second adhesive layer has a thickness of 1000 μm or less.

12. The optical adhesive sheet according to claim 1, wherein the first adhesive layer and/or the second adhesive layer contains an acrylic polymer as a base component.

13. The optical adhesive sheet according to claim 2, wherein the first adhesive layer and/or the second adhesive layer contains an acrylic polymer as a base component.

14. The optical adhesive sheet according to claim 3, wherein the first adhesive layer and/or the second adhesive layer contains an acrylic polymer as a base component.

15. The optical adhesive sheet according to claim 1, wherein the first adhesive layer and/or the second adhesive layer is a cured product of an adhesive composition curable with an active energy ray.

16. The optical adhesive sheet according to claim 12, wherein the first adhesive layer and/or the second adhesive layer is a cured product of an adhesive composition curable with an active energy ray.

17. A polarizing film with an adhesive layer, comprising a lamination structure including:
a polarizing film; and
the optical adhesive sheet according to claim 1.

18. A liquid crystal display device comprising the optical adhesive sheet according to claim 1.

19. A liquid crystal display device comprising a multilayer structure including:
a resin-made covering member;
a liquid crystal panel having a polarizing film thereon; and
the optical adhesive sheet according to claim 1 located between the resin-made covering member and the liquid crystal panel, the optical adhesive sheet being attached to the resin-made covering member on the side of the first adhesive layer and attached to the polarizing film of the liquid crystal panel on the side of the second adhesive layer.

20. The liquid crystal display device according to claim 19, wherein the liquid crystal panel comprises on-cell type touch sensors or in-cell type touch sensors.
